(19) United States
(12) Patent Application Publication
(10) Pub. No.: US 2008/0082515 A1
(43) Pub. Date: Apr. 3, 2008

(54) METHODS AND SYSTEMS FOR INITIATING PHONE CALLS USING A PREDICTIVE DIALER

(76) Inventor: Mark B. Gould, Los Angeles, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/866,658

(22) Filed: Oct. 3, 2007

Related U.S. Application Data
(60) Provisional application No. 60/849,279, filed on Oct. 3, 2006.

(51) Int. Cl. G06F 17/30

(52) U.S. Cl. 707/4; 707/10; 707/E17.008; 707/E17.01

(57) ABSTRACT

An example calling system includes a dialer, a user interface via which a user can select one or more call lists from a plurality of call lists from different call list providers, and software stored in computer readable memory configured to cause at least in part phone numbers to be streamed from the one or more user selected call lists to the dialer so that the dialer can dial the phone numbers.

### CROSS-REFERENCE TO RELATED APPLICATIONS

The present application claims priority from U.S. Patent Application No. 60/849,279, filed Oct. 3, 2006, the content of which is incorporated herein in its entirety.

### STATEMENT REGARDING FEDERALLY SPONSORED R&D

Not applicable.

### PARTIES OF JOINT RESEARCH AGREEMENT

Not applicable.

### REFERENCE TO SEQUENCE LISTING, TABLE, OR COMPUTER PROGRAM LISTING

Not applicable.

### BACKGROUND OF THE INVENTION

1. Field of the Invention

The present invention relates to telecommunications, and in particular to methods and systems for placing voice calls.

2. Description of the Related Art

Automated dialers, such as auto-dialers and predictive dialers, are increasingly used to contact called parties in an efficient manner, thereby reducing the manual effort and time expended by calling parties. However, the communication between the phone number providers, the calling parties, and the automated dialers has often been cumbersome, and often provides unsatisfactory feedback regarding the success of calls placed using such automated dialers.

### SUMMARY OF THE INVENTION

An example embodiment provides a calling system, comprising: a user interface configured display prospect database identifiers associated with a plurality of database associated with a plurality of database providers; a user interface configured to receive a prospect search query from a user; a search engine configured to locate one or more sets of leads corresponding to the prospect search query; a user interface configured to display identifiers corresponding to one or more of the located sets of leads and to receive a user selection; programmatic code stored in computer readable memory configured to cause, at least in part, lead phone numbers corresponding to the user selection to be provided to an autodialer associated with the user; and

a user interface configured to receive status indications from the user with respect to at least a portion of the streamed leads, wherein the status indicates corresponding call results.

An example embodiment provides calling system, comprising: a dialer; a user interface via which a user can select one or more sets of prospects from a plurality of sets of prospects from different providers; and programmatic code stored in computer readable memory configured to cause at least in part phone numbers to be streamed from the one or more user selected sets of prospects to the dialer so that the dialer can dial the phone numbers.

An example embodiment provides method of providing contact information, comprising: causing at least in part identifiers for a plurality of databases storing contact information for leads from a plurality of providers to be displayed to a user via a user display; receiving over a network a user selection of at least a portion of at least one of the databases; at least partly causing phone numbers corresponding to the selected portion to be transmitted to a dialer; receiving over the network user specified call status for calls completed via the dialer and connected to the user; and storing the user specified call status in a data store.

An example embodiment provides system for controlling calling, comprising: a user interface including a field via which a first user can specify a maximum permissible cost for leads that can be used by a first set of users; a data store configured to store the maximum permissible cost specified by the first user; and a report generator configured to generate a report with respect to how many lead phone numbers were utilized by the first sets of users and the cost associated cost on a per lead basis.

### BRIEF DESCRIPTION OF THE DRAWINGS

Exemplary embodiments are illustrated in the accompanying drawings, which are for illustrative purposes only. The drawings comprise the following figures, in which like numerals indicate like parts.

FIG. 1 illustrates an example logic diagram.

FIGS. 2-7 illustrate example user interfaces.

FIG. 8 illustrates an example process.

FIGS. 9A-K illustrate additional example user interfaces.

FIGS. 10A-B illustrate example networked system configurations.

### DETAILED DESCRIPTION OF PREFERRED EMBODIMENTS

The present invention relates to telecommunications, and in particular to methods and systems for placing voice calls.

Certain example embodiments enable a user to select a leads database from a plurality of leads databases offered by a plurality of vendors from a central source, such as a third party that aggregates information regarding lead databases from such vendors. For example, a menu of leads databases from different vendors can be transmitted over a network, such as the Internet, to a user terminal. The user can then select one or more leads databases, or subsets thereof, from one or more suppliers.

In an example embodiment a computer system, such as a server, can stream contact information (e.g., phone numbers) corresponding to leads from the selected leads databases to a dialer, such as an autodialer or predictive dialer (e.g., an autodialer or predictive dialer configured to be coupled to a circuit switch network, such as a PSTN and/or a packet network, such as a Voice over IP network) as needed to place calls. Optionally, one or more of the selected leads databases, or selected portions thereof, can be downloaded as a file to the predictive dialer, and the predictive dialer can access and place calls to the phone numbers of the leads. The called leads can be connected to a user phone (e.g., once and if the call is completed, or as soon as the phone number is dialed), such as a user engaged in making phone solicitations for a good or service.

Optionally, information regarding the called lead (e.g., some or all of the following: name, other identification information, income information, home ownership status (own/rent), asset information (e.g., stock portfolio information), employer identification information, age, address, number of years at current address, a link to current weather information in called lead's area, number of children in household, marital status, number of times previously solicited for one or more goods and services, the result of the prior solicitations, etc.) can be included in a lead record and optionally displayed to a user prior to, during, and/or after the call. Optionally, a user can provide the leads system, via a user interface, additional or updated lead information based on information obtained by the user during a lead call. The additional or updated information can then be stored and optionally transmitted to the lead provider.

Optionally, the dialer or other system can transmit information regarding calls placed by the dialer. For example, some or all of the following can be stored in computer readable memory and transmitted to one or more designated recipients (e.g., the leads database vendor): the number of calls successfully completed, the number of calls not successfully completed, the reason a given call was not successfully completed (e.g., disconnected, no answer, busy signal, etc.), and the duration of the successfully completed calls. The user can provide other types of status information as well for completed calls (e.g., lead deceased, lead not interested, answered by automatic answering device and left message, etc.). The call information can be used to generate billing reports, progress reports for users, departments, and companies, and/or to update a leads database (e.g., to delete database entries having disconnected phone numbers), etc.

Throughout this disclosure, the term “website” is used to refer to a user-accessible server site that implements the basic World Wide Web standards for the coding and transmission of hypertext documents. These standards currently include the hypertext markup language (HTML) and the hypertext transfer protocol (HTTP). The term “site” is not intended to imply a single geographic location, as certain websites or other network sites include multiple geographically distributed computer systems that are appropriately linked together. Furthermore, while this disclosure describes certain embodiments that use the Internet and related protocols, other networks, such as networked interactive televisions, and other protocols are used in other embodiments.

Additionally, unless otherwise indicated, the functions described herein are performable by software including executable code and instructions running on one or more general purpose computers. In an exemplary embodiment, the computers include one or more central processing units that execute program code and process data. The computers also include memory, including one or more of volatile memory (such as random access memory for temporarily storing data and data structures during program execution), non-volatile memory (such as a hard disc drive, optical drive, or flash drive, for storing programs, data, and databases), and one or more network interfaces for accessing an intranet and/or Internet. However, other embodiments are implemented using special purpose computers, state machines, and/or hardwired electronic circuits.

The computers optionally include a display for displaying user interfaces, data, photographs, images, and the like. In certain embodiments, the computers also include one or more user input devices, such as a keyboard, mouse, pointing device, microphone and the like, used to navigate, provide commands, enter information, and the like.

Furthermore, where this disclosure refers to “clicking on” a link or button, or pressing a key in order to provide a command, make a selection, or to provide data, in other embodiments the commands, selections, and data input are made using other input techniques, such as using voice input, pen input, or mouse input, including hovering over an input area, selecting menu options, and the like. In addition, while several of the examples described herein are with reference to investment leads or prospects, the leads can be prospects for other goods and services, and corresponding user interfaces can be used.

Unless otherwise specified, the term telephone number refers generally to a telephonic address, such as, without limitation, a standard POTs telephone number, an E.164 phone number (ITU-T recommendation which defines the international public telecommunication numbering plan and telephone format used in a Public Switch Telephone Network (PSTN) and certain data networks), or a Voice over Internet Protocol (VoIP) address.

The calls discussed herein can be placed over a circuit or packet switched network, such as the Public Switched Telephone network, an Internet protocol network, a VoIP network, other networks, or a combination of two or more of the foregoing networks.

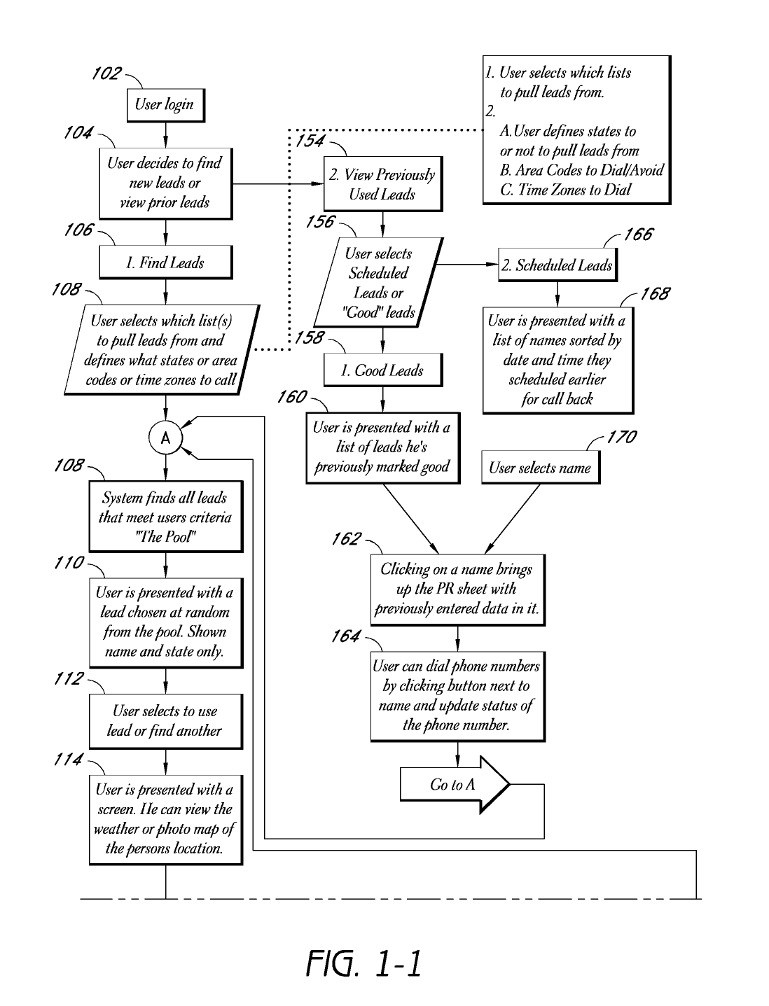

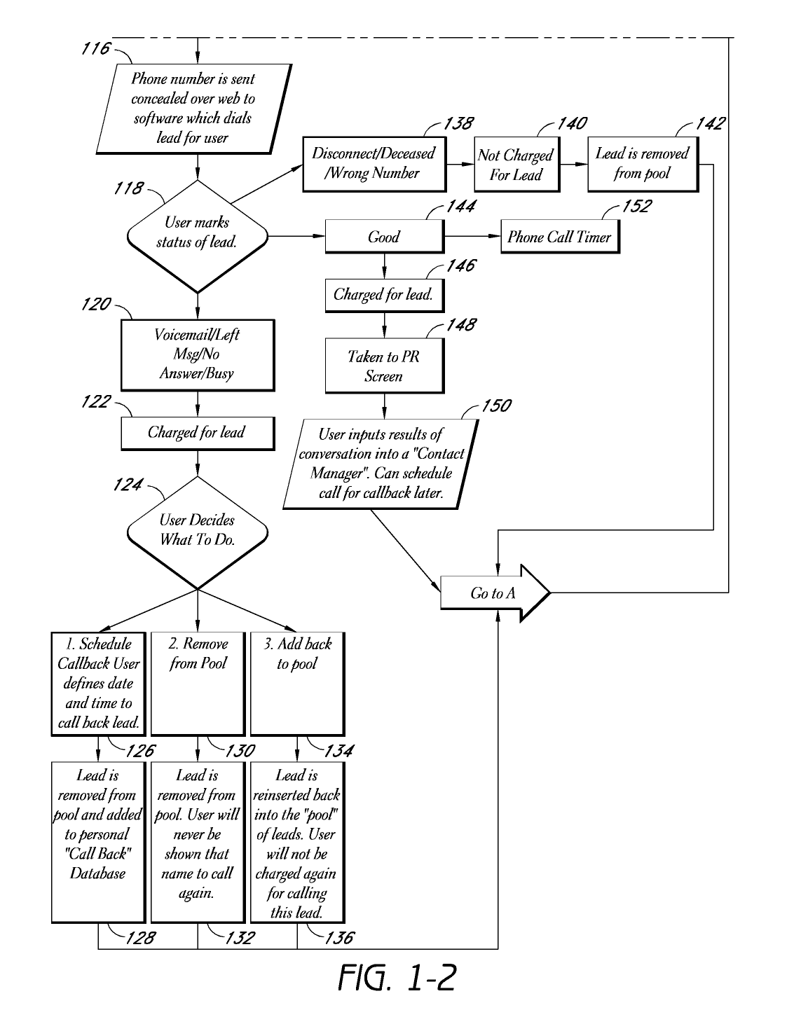

An example calling process is illustrated in FIG. 1, which will be discussed in greater detail below. Access to a leads database is provided locally or over a network. For example, a wide area network, or WAN, such as the Internet, can be used. The leads database can be maintained and/or hosted by a service provider (e.g., the database provider or a third party).

The leads database includes one or more leads records. By way of example, a leads record can include some or all of the following information and/or different information:

name;

other identification information;

income information;

credit report information;

occupation;

level of education;

educational institutions attended (e.g., names of elementary school, high school, collages, etc.);

home ownership status (own/rent);

investment asset information (e.g., stock portfolio information);

employer identification information;

age;

address;

number of years at current address;

a link or pointer to current weather information in leads area;

number of children in household;

children's' age;

marital status;

number of times previously solicited for one or more goods and services;

the result of the prior solicitations.

The process illustrated in FIG. 1 can optionally be implemented using software installed and hosted on one or more computer systems (e.g., a client terminal/server, a remote host, etc.). The user interfaces described herein can optionally be provided to and accessed via a browser (e.g., an application used to access information on the Internet, such as on the World Wide Web), or via a non-browser-based interface. Certain interfaces described herein may be used by telephone solicitation sales organizations.

A given user terminal involved in the process optionally includes an automatic phone dialup feature, such as a modem and corresponding software. Optionally, instead or in addition, a dialer, such as an auto-dialer or a predictive dialer is remotely located from the user terminal. The user terminal optionally hosts a browser and is coupled to a network, such as the Internet.

In response to a user request (e.g., a request from a member of telephone solicitation sales organization), lead data (e.g., data for a plurality of leads) is accessed from a leads database. All or portions of the accessed lead data are delivered from the database over the network to the user's terminal or a separate dialer system such as an auto-dialer or a predictive dialer. Optionally, the telephone solicitation sales organization is not billed for receiving such leads data prior to the organization's calling of leads. Optionally, a user is billed for leads after such leads are called if one or more specified call results occurred. Optionally, the telephone solicitation sales organization is billed for receiving such lead data even if leads are not called.

In response to a phone solicitor action (e.g., activating a “display lead” control, otherwise requesting a lead, terminating an in progress call, etc.), or an action of a manager of a phone solicitor, the user is presented with one or more leads, including some or all of the lead record information discussed above. Optionally, the user is, at this juncture, prevented from viewing the lead's phone number and/or other contact information, even though, the user terminal and/or the auto-dialer or predictive dialer have received the phone number. Optionally instead, the user is, at this juncture, allowed to view the lead's phone number and/or other contact information.

The auto-dialer or predictive dialer then dials the telephone number associated with the lead, optionally still without disclosing the phone number to the user. If the call was dialed by certain auto-dialer configurations, the user may be connected to the called lead line and so may hear the called phone ringing and will hear if the called phone is answered. If the phone number is dialed by a predictive dialer or certain auto-dialer configuration, optionally the dialer places an outcall to the lead's phone number, and if the lead answers the call, the user telephonic device is coupled to the out call (e.g., a call is placed from the dialer to the user phone, and the out call to the lead is bridged with the call to the user terminal).

If the called phone is answered, the user may make voice contact with the lead and this may result in a benefit to the user. For example, the lead may accept or agree to a sales contract for an item or service being offered by the user. The call may also result in a negative or a neutral result. For example, if the lead's phone number is busy, the user can indicate that a call should be placed to the lead at a later time (e.g., wherein such indication can be stored on a calendar associated with the user at a date/time specified by the user or at a date/time automatically selected by the dialer or other software). If the phone number is inactive or a “wrong number,” the user is able to identify this (e.g., by clicking on an inactive/wrong number user input, wherein the identification of the number as inactive/wrong number is optionally stored in association with the phone number and/or the phone number is removed from the leads database). Optionally, the user and will not be invoiced/charged for such unsatisfactory lead.

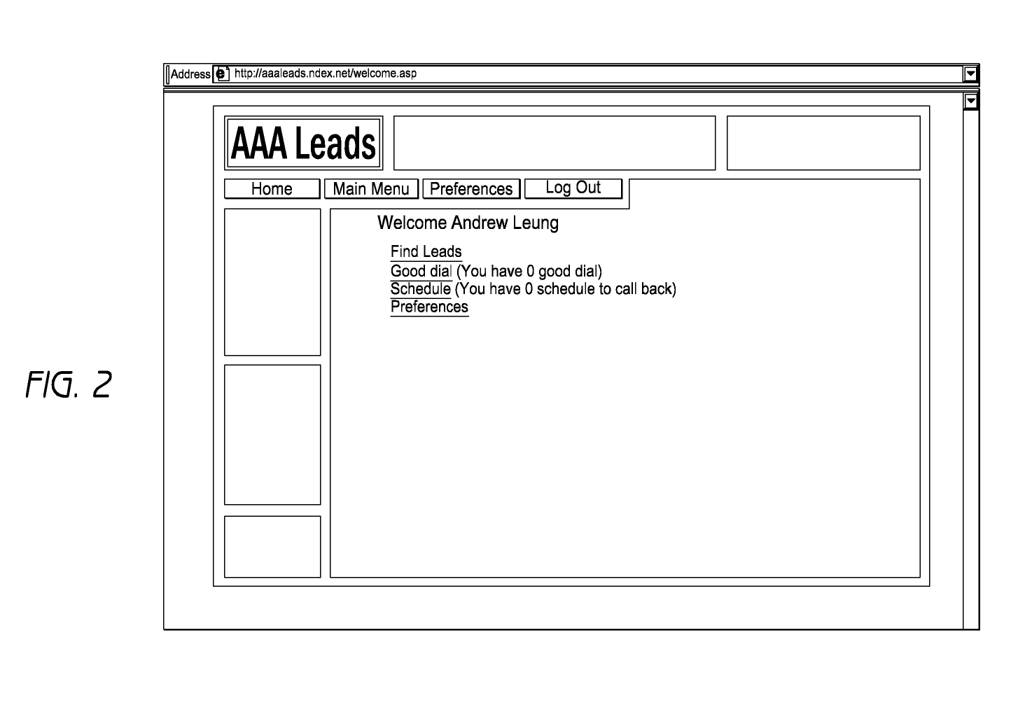

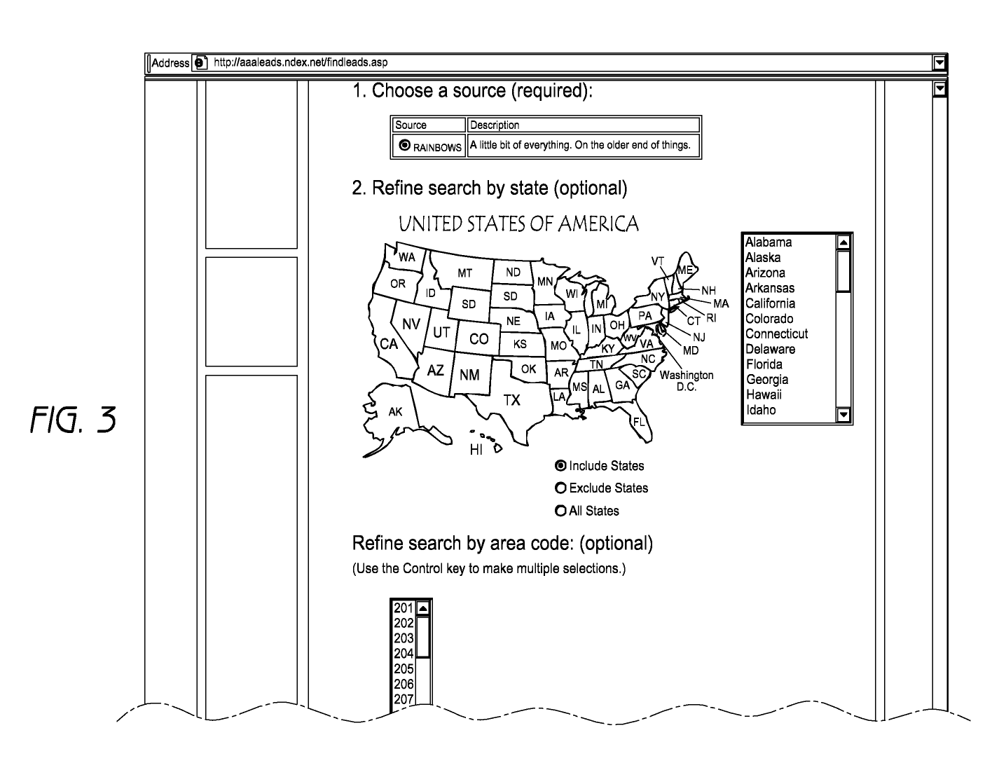

FIGS. 2-7 illustrates example user interfaces. FIG. 2, illustrates an example welcome screen which appears upon initialization. Choices may be made by mouse selection, or otherwise, from: Find Leads, Good Dial, Schedule and Preferences. Upon selection of Find Leads, the user interface illustrated in FIG. 3 is displayed, from which a source of database information may be selected, including geographical location. This user interface is only an illustrative example of the types of choices that may be provided and made via a user interface, and such choices may extend to many other categories including industry (SIC code), phone area code, county, state, city, zip code, etc.

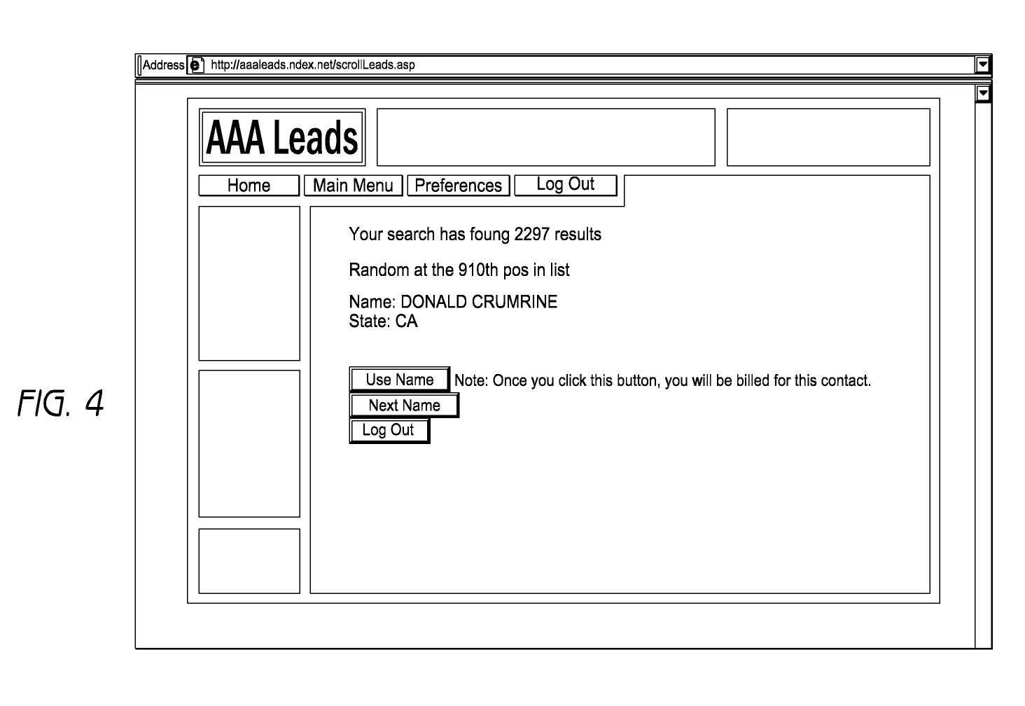

Once a database or subset thereof has been selected, as shown in FIG. 4, the size of the selected database or subset thereof (e.g., the number of matching leads) is displayed and a first entry or lead is identified. In this case, Donald Crumrine is the first lead. This example displays the lead's name and state, although different and/or additional information relating to the lead can be presented a well (e.g., city, zip code, current time in lead time zone, gender, income, debts, homeownership status, household size, average home value in the lead's zip code, car type, etc.). The user may chose to use the name presented or move to the next name due to geographical location, gender, income, debts, homeownership status, household size, car type, or other factor, wherein certain factors may be more relevant than other factors depending on the service or product being offered.

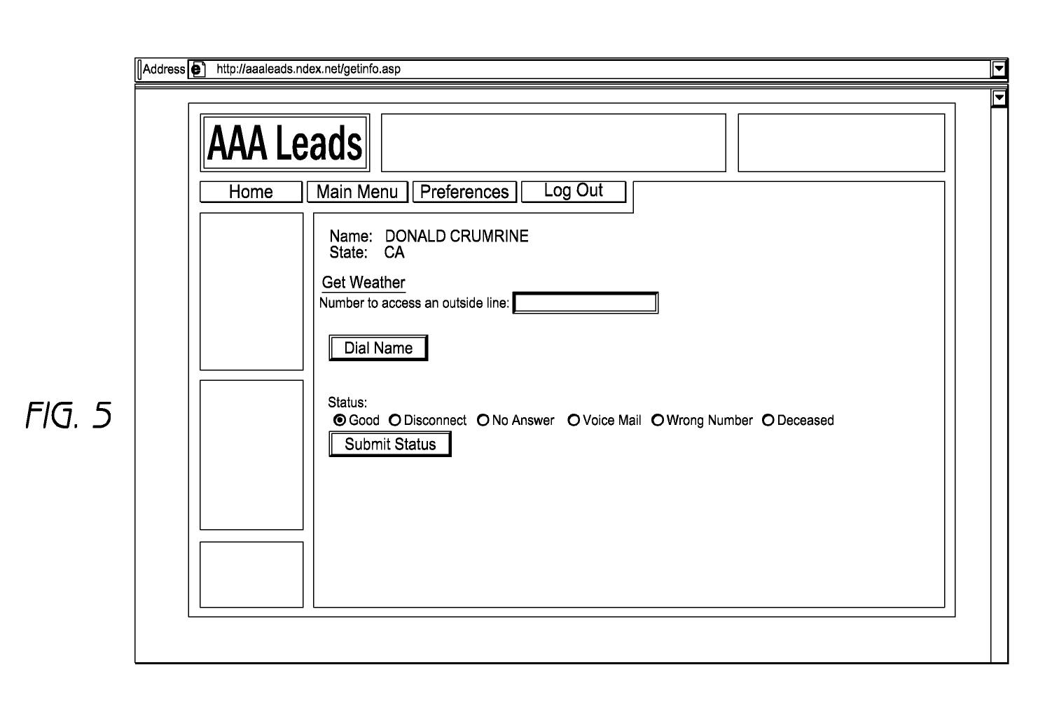

The user interface illustrated in FIG. 5 provides a dial outside line field (via which the user may manually enter a number to be dialed to access an outside line, such as the number “9” or other appropriate input), a dial name control, a get weather control/link, a status selection interface (e.g., providing “good”, disconnect”, “no answer”, “voice mail”, “wrong number”, “deceased”, and/or additional, fewer, or different status selections, such as “good”, “voice mail”, “no answer”, “not interested”, “wrong number—call time exceeded”, “disconnect—call time exceeded”, “deceased—call time exceeded”, “wrong number”, “disconnect”, “deceased”), and a submit status control. In this example, if the user activates the dial name control, and the system, via the autodialer, automatically dials the lead, optionally without disclosure of the lead's phone number to the user.

A status is selected by the user via the status selection interface depending on the outcome of the call. For example, if contact is made with a party that represents the lead, “Good” is selected by the user as shown in FIG. 5. If the called phone number is disconnected, the “disconnect” status may be selected. If there is no answer, the user may select the “no answer” status. If a message is left on voice mail, the user can select the “voice mail” status. If the call is to a wrong number, or the party is permanently not available at the number dialed, such status (e.g., “wrong number”, “deceased”) may be selected.

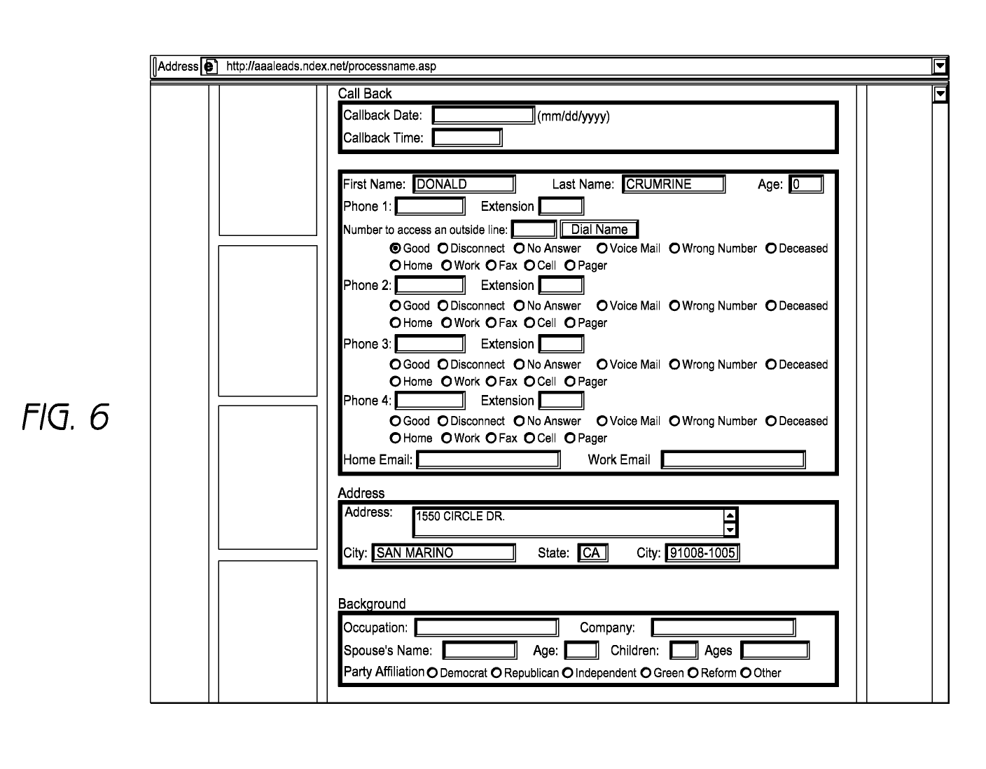

FIG. 6 illustrates an example user interface via which a user may log call details for a given lead, including, callback information and lead contact information including background. In this example, the user interface includes a callback date field, a callback time field, a first name field, a last name field, a lead age field, a phone 1 field, a phone 1 extension field, a field configured to receive a number to access an outside line, a dial name control, a status selection interface (e.g., providing “good”, disconnect”, “no answer”, “voice mail”, “wrong number”, “deceased”, and/or additional, fewer, or different status selections), and a phone location selection interface (e.g., home, work, fax, cell, pager). Similar fields and controls can be provided for additional phone numbers.

This example user interface includes a home email field, a work email field, and address fields (e.g., street address, city, state, zip code fields). A lead “background” user interface includes an occupation field, a company name field, a spouse's name field, an age field, a number of children field, a children ages field, and a affiliation selection user interface (e.g., Democrat, Republican, Independent, Green, Reform, other). Optionally, some or all of fields may be prepopulated with information obtain from the original lead record. Optionally, the information entered by the user is stored in the lead record and later displayed to the user and/or other user when the lead is next presented. Optionally, a user is provided the ability to email or otherwise provide a lead's prospect's information to a recipient, such as another broker, management, etc.

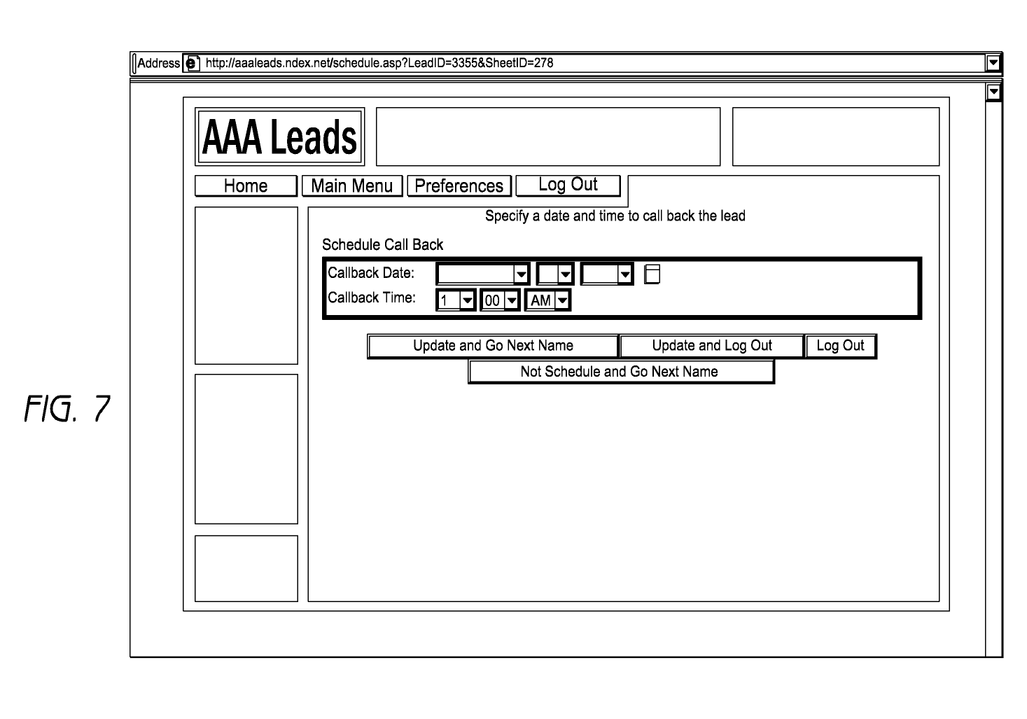

FIG. 7 illustrates an example call back scheduler user interface. The user may enter a callback date and time reminder to call the lead back at a future date and time. An update and go to next name control is provided, which, when activated, causes the data entered in the illustrated user interface to be saved, and causes the next lead to be presented (e.g., sequentially, randomly, or otherwise). An update and logout control is provided which, when activated causes the data entered in the user interface to be saved, and causes the user to be logged out of the system. A “not schedule and go next name” control is provided which, when activated goes the next lead to be presented without saving a callback reminder. Optionally, the user (e.g., an agent or broker) or supervisor can set an alarm (e.g., which will provide a pop-up reminder in the form of a window listing the lead name, date, and time) to remind the broker of scheduled call backs at periodic or specified times.

Optionally, the user can designate a given lead provided by the database as a good or bad lead contact, (e.g., good: “good”—answered by the named lead, or bad: “disconnect”—the phone number is disconnected, “no answer”, “voice mail”, “wrong number”, “deceased”). Optionally, a lead is only billed for if it is indicated to be a good lead and/or a good connection. In an example embodiment, calls that result in disconnects, no answer, wrong number, and/or permanently not available are not charged for, while calls that result in contact with the named lead (good), or that result in the user leaving a voice mail message for the lead are counted as billable and are charged for. Optionally, a billing event for a given lead does not occur for leads in the selected and provided database until the lead is designated as good by the user (e.g., the user contacted the lead or left a message for the lead).

A designated user may change the selection of the database to correspond to a different desired geographical location, time zone, standard industrial code, mail zip code, telephone area code and/or any other preference. Thus, a previously selected database may be cancelled and a new database may be selected, without a billable event taking place as a result of the switch in certain circumstances. As similarly described above, invoicing for leads in the new database are optionally billed for only after a given lead is used and/or designated as a good lead (e.g., the user connected with the lead or left a voice mail message for the lead).

Referring now to FIG. 1, at state 102, a user logs in into the leads system. At state 104, the user elects to find new leads or to view leads that were previously used by the user (e.g., the user may select to view a new leads database or view a previously used database/selection of leads). If the user decides to find new leads, the process proceeds to state 106, where a find new leads process is initiated. Optionally, a supervisor or other authorized person can place limits or provide other settings regarding which leads and/or leads databases a user can access. For example, a supervisor may specify a maximum cost per lead for a given user or class of users. Further, a supervisor may specify that only pre-selected databases can be used by brokers or other agents. The supervisor settings can be stored in memory in association with a user record and/or a company record.

At state 108, the user submits leads criteria (e.g., some or all of the following: a city, state, zip code, area code, time zone, in which the leads are to be located, an income level, an age, a gender, homeowner status, occupation, marital status (single, married, divorced, etc.), household size, number of children, age of children, education level, etc.). The criteria can be expressed positively, (e.g., leads should be in the specified city, state, zip code, or area code, or have a specified income level, age, gender, homeowner status, occupation, marital status) and/or negatively (e.g., leads should not be in the specified city, state, zip code, or area code, or have a specified income level, age, gender, homeowner status, occupation, or marital status). At state 108, the system searches through available databases (or a subset thereof, such as available databases selected by the user) to identify leads that satisfy the user criteria.

At state 110 the user is presented, via a user interface, with a lead randomly, sequentially (first lead first, second lead second, last lead last), alphabetically, or otherwise selected from the identified leads. If random selection is used, optionally, a pseudo-random number between the cardinal numbers represented by the first entry and the last entry is generated using a randomizer RND function. The system software identifies leads that have been used called on behalf of the user and/or other users, and optionally excludes them from the next random selection so that the user does not unintentionally call the same lead twice.

Optionally, the lead selection process chooses a lead based on the number of times available leads in a result set have been contacted previously. The leads that have been contacted and/or dialed relatively more often (e.g., more than the average for the leads) are given a relatively lower priority so that they are less likely to be called again before those with a relatively higher priority (e.g., leads that have been contacted and/or dialed relatively less often/less than the average for the leads). The selection processing can use random selection with a weighting based on the corresponding priority associated with the leads. This ensures a more even distribution of calls to leads, and prevents or reduces the chance that certain leads will be dialed more often than other leads overall. Optionally, a call frequency can be specified for a lead or group of leads. Optionally, a call limit per specified period of time can be set (e.g., set in memory is associated with a lead set identifiers or an individual lead) for a given lead or a given set of leads (e.g., set in memory and associated with a lead set identifiers or an individual lead) so that a lead with not be called more than the limit in the specified time period. For example, a limit of one call per week can be set, or a limit of three calls per month can be set for a specified lead or set of leads (e.g., a lead database).

Optionally, only select information stored in a lead record associated with the lead is presented to the user. For example, optionally the lead phone number is not displayed to the user while certain other data (e.g., including some or all of the following: a city, state, zip code, area code, in which the leads are to be located, an income level, an age, a gender, homeowner status, occupation, credit rating, current mortgage amount, marital status, household size, number of children, age of children, and/or education level) is. At state 112, the user indicates that the presented lead is to be called or indicates that the system should provide a different lead.

At state 114, a user interface is presented displaying a map (e.g., a weather map, a photo map, a conventional map, or other map) of the lead's location. Optionally, the map can be a photo map wherein the user can specify a zoom level. For example, the user can zoom in to clearly display the lead's location (e.g., house or place of business), or can zoom out to display a neighborhood, city or other area. For example, the user can view the lead's house to determine whether the house has a pool, the yard size, the house roof type, and so on, which may provide an indication as to the lead's potential need for certain housing related goods and services (e.g., house painting services, mortgage services, etc.). The weather map can display the current and predicted weather conditions (e.g., temperature, rain, snow, humidity, storm, and/or other information) for the lead's location. Other localized content can be provided as well (e.g., news, sports information, event information, etc.).

Optionally, the system or user can initiate a search regarding the lead. For example the system can submit a search query to a local and/or Web-based search engine (e.g., Google, Yahoo, MSN, etc.) that have access to one or more databases (e.g., an index/data store of Web pages, private credit databases, and/or other databases) using certain information related to the lead as search terms (e.g., the lead's name, city, state, address, zip code, phone number, age, occupation, marital status, and/or educational institutions attended by lead, etc. All or certain higher ranked search results (e.g., the top three results) are then transmitted to the user's computer terminal for display to the user. All or certain higher ranked search results (e.g., the top three results) are then displayed to the user. Optionally, the user and/or a supervisor can specify how many results are to be returned and/or displayed to the user. The search results can provide the user with additional information and news about the lead, which can help the user better project or infer what the lead's needs or interests might be and can help establish a better rapport with the lead.

At state 116, the phone number for the selected lead is dialed by a dialer, optionally without displaying the phone number to the user. For example, if the automatic dialer is located remotely from the database, the system may retrieve the phone number from the database, transmit the lead over a network, such as the Internet, to which the dialer is connected, and the dialer dials the lead's phone number.

At state 118, the user, by listening to the call result (e.g., a busy tone, a disconnect message, a ring no answer condition, answered by voice mail, a wrong number indication), determines the call status. The user then indicates the call status, using, by way of example, one of the user interfaces described above. Optionally, the call status can be automatically determined by the dialer or other device (e.g., by monitoring the phone line and detecting busy tones, voice mail answering, ring no answer, etc.), and the call status can be stored in the call lead record. Optionally, if the call status will result in a charge for the corresponding lead, once the call status in provided by the user, the lead phone number is displayed to the user via the user terminal display.

In an example embodiment, a call timer is provided via the system which enables time management by the user, wherein the user can review, using the timer, the amount of time spent talking to a given lead and the time duration relationship to closed orders or lead compliance. The timer also thwarts or inhibits the user from falsely claiming that a lead was not contacted when, in fact, time was logged in discussions with the lead where such time duration may be found to be inconsistent with a non-billable event. All calls or a subset thereof, are optionally logged so that the service is informed as to the time of day calls were placed and the duration of each said call. The call time and billing status is optionally displayed on the user's terminal monitor and is optionally provided to an audit and/or billing system.

Optionally, an audit system automatically flags to an administrator calls that were assigned a non-billable status by the user (e.g., a “bad” lead), but that the timer indicates lasted at least a certain period of time (e.g., at least 30 seconds, at least 60 seconds, or other period of time). The administrator can then decide if the user is to be billed for the lead, can verify the status (e.g., by calling the lead), and/or can discuss the status with the user. For example, the audit system may provide the following example flags: “wrong number—call time exceeded”, “disconnect—call time exceeded”, “deceased—call time exceeded”, when a wrong number, disconnect, or deceased status was provided, but the user's call time to the lead exceeded a predetermined amount of time. Optionally, the user is automatically billed for leads where the call to the leads are at least of a first duration (e.g., at least 30 seconds, at least 60 seconds, or other period of time) regardless of the lead status provided by the user.

At state 120, the system examines the lead status and determines if the status indicates that the user did not speak to the lead, but that the lead status still is to be considered billable. In this example, a determination is made as to whether the status is one of: left message on lead's voice mail system, no answer, or busy. If the status meets one of the foregoing criteria, at state 122, a charge is to be made for the lead. However, fewer, more or different status may cause a charge to be made for the lead. For example, optionally, in an example embodiment, a “no answer” status does incur a charge for the lead.

At state 124, if the call to the lead was not satisfactory, the user decides how next to proceed. For example, the user can decide to schedule a callback to the lead at a specified date and time (state 126), and at state 128 the lead is removed from the pool of identified leads and added to a personal call back database so that the lead will be called at the data/time designated by the user. The user can also instruct the system to remove the lead from the pool of identified leads (state 128) so that the lead will not be selected by the system for the user again (state 130). The user can also specify that the lead is to be added back to the pool of identified leads (state 134), so that the lead will be called in the future at a time and date selected by the system (state 136), wherein the user will not be charged twice for the lead. As illustrated, the process then proceeds back to “A”.

If, at state 118, the user indicates that the status of the lead call is a non-billable status (e.g., disconnected, deceased, or a wrong number) the process proceeds to state 138. At state 140, based on the status provided by the user, a determination is made that the user is not to be billed for the lead. The process then proceeds back to “A”.

If, at state 118, the user indicates that the call lead status is good (e.g., the user spoke to the lead), the process proceeds to state 144. At state 146 a determination is made that a charge is to be made for the lead. At state 148, the system provides a prospect (PR) user interface form, such as that illustrated in FIG. 6. At state 150, the user can input the results of the call conversation into the form (e.g., additional information regarding the contact, an indication as to whether a sale was made, updated information, etc.). The user can also schedule a callback to the lead, as similarly discussed above with respect to FIG. 7. The process then proceeds back to “A”.

A phone call timer can be initiated once a call is placed to time the duration of the call (state 152) placed at state 116. The timer enables the user to review the amount of time spent talking to a given lead and the time duration relationship to closed orders or lead compliance. The timer also thwarts or inhibits the user from falsely claiming that a lead was not contacted when, in fact, time was logged in discussions with the lead where such time duration may be found to be inconsistent with a non-billable event. Calls may be logged so that the system, an administrator, or a supervisor can review the time of day calls were placed and the duration of the calls.

Referring back to state 104, if the user selected previously used leads, the process proceeds to state 154, and one or more of the selected leads are presented to the user via the user terminal. At state 156, the user indicates whether the user wants to utilize leads previously marked as being “good” leads, or whether the user wants to utilize leads for which there is a scheduled callback.

If the user selects good leads, the process proceeds to state 158. At state 160, the user is presented with one or more leads that the user (or other designated person) has previously indicated is a good lead. The user can select a name at state 170, or at state 162, if the user selects a given lead from the list of good leads, the system presents the PR form with previously entered data regarding the lead. At state 164, the user can initiate the call by activating a call control. The user can then update the status for the lead as similarly discussed above. The process then proceeds back to “A”.

If the user selects scheduled leads at state 156, the process proceeds to state 166. At state 168, the user is presented with one or more leads (e.g., by name). The leads may be sorted by date and time, alphabetically or otherwise.

Example lead selection processes will now be described in greater detail. A user can select from one or more leads databases from a menu of leads databases. For example, the menu can include one or more of the following categories and/or different categories:

investment purchaser leads;

mortgage leads;

insurance leads;

home remodeling leads;

travel leads;

mortgage and gas leads;

leads for moving services;

leads to new businesses;

leads to business executives;

leads for business supplies purchasing agents;

entertainment leads;

political contributor leads;

charitable contributor leads;

leads in certain professional categories (e.g., lawyers, doctors, accountants, medical professionals (e.g., dentists, optometrists, chiropractors, etc.)).

Once the user selects a category, a listing or other presentation of the corresponding leads databases/lists is presented to the user on the user terminal. The leads can be from multiple leads database providers. The providers optionally have a contractual agreement with an intermediary service provider which provides the leads database menus and listings described herein to a user. Optionally, some or all of the following information and/or additional or different is provided for displayed leads databases:

leads database name;

description of leads database/list;

name of leads database provider;

cost per lead called;

cost to license entire database for a periodic fee (e.g., per day, per week, per month, per three months, per year, etc.);

number of leads in the database;

when the database was last updated.

Optionally, a search field or search fields are provided via which the user can enter leads database criteria (e.g., a city, state, zip code, area code, time zone, in which the leads are or are not to be located, an income level, an age, a gender, homeowner status, occupation, marital status (single, married, divorced, etc.), household size, number of children, age of children, education level, etc.), and a search engine will locate the leads databases corresponding to the criteria or other search terms. Optionally, the search results are presented in relevance order with respect to the criteria/search terms. Optionally, a leads database provider can pay to have there database(s) placed higher in the search results, or to be otherwise emphasized (e.g., bolded, displayed in a different color other search results, displayed in conjunction with a particular icon or animation, etc.). Optionally, a wizard is provided to aid a user in selecting a leads database.

Once a user (e.g., a manager or an individual broker/agent) selects a database or databases, the database(s) can be accessed using one or more techniques. For example, an entire selected leads database can be downloaded into a dialer system (e.g., an autodialer or predictive dialer), and the leads can then be called (e.g., in random or pseudo-random order, alphabetically, leads with the best status first, leads with the worst status last, or in a different ordering). Optionally, the leads can be streamed from the database provider, or via an intermediary system optionally operated by a third party, to the dialer on an “as needed” basis. For example, the leads can be automatically streamed to the dialer one at a time, five at a time, one hundred at a time or other desired number of leads. The number of agents that are going to be using the leads database can affect the number of leads streamed at a time and/or the frequency at which leads are streamed. The number of leads streamed at a time is optionally specified by the leads provider, an intermediary, or the user.

The results of the leads called by the dialer can be stored in a lead results database. Optionally reports can be generated, sent (e.g., as an email or SMS message), or accessed in substantially real time (e.g., via a Website), enabling a supervisor or other person or system to monitor the progress of a particular agent or a group of agents in substantially real time. For example, the report can list the name of the agents, the status of the agent calls, how many and which leads purchased the products or services being offered by the agents, the names of the leads, the names of the lead provider, the cost per lead, etc.

The reports can be used for audit and/or billing purposes. For example, the reports can be requested and presented via a browser-equipped computer terminal remote from and coupled over a network to the leads results database. Certain information can also be provided to the database provider or other party (e.g., the number of good leads, the number of bad leads, the number of leads that result in a commercial transaction being completed, the status of the leads, etc.). An authorized user, such as a supervisor, can view the reports to decide whether or not to halt use of one or more leads databases and whether different leads sources should be used.

Thus, the user interfaces discussed provide access to lead list database products and enables an end-user (e.g., a broker or other agent) or manager to choose the source of the leads, and to further refine to their choice of leads.

The following optional user interfaces provide further control on the selection and use of leads. A user interface (e.g., a “Scrub Against My Account” control) is optionally provided via which a user can instruct or indicate to the system that certain leads should not be provided to the user again (or within a specified period of time) if such leads have previously been provided to or used on behalf of the user (optionally, even if provided by a different provider), to prevent duplicate calls by the user to those leads.

A user interface (e.g., an “Export Leads” control) is optionally provided via which a user can instruct the system to export leads (e.g., lead information, such as addresses, phone numbers, or other information) that the user has already been charged for, for use in a mailing campaign (e.g., to generate a mailing list and/or mailing labels) or for backup purposes.

A user interface (e.g., a “Lead Limit” control) is optionally provided via which a user can instruct or indicate to the system that only a certain number of leads are to be called, and further authorization is needed to call additional leads (e.g., for an authorized supervisor), to thereby control costs associated with calling leads.

A user interface (e.g., a “Sample Chunk” control) is optionally provided via which a user can instruct or indicate to the system that the user wants the entire list matching their criteria to be called as part of the leading calling process, or if the user wants a sample of the leads (e.g., 10 leads, 20 leads, 50 leads, 2% of the leads, etc.) matching the criteria to be called to test the quality or appropriateness of the matching lead list.

Optionally, the lead call data (e.g., phone numbers) for the matching leads or a sample thereof can then be downloaded or streamed to the dialer across a WAN (Internet) without requiring an end-user to manually load the lead data into the dialer. Optionally, the user is not charged for calls placed to the leads sample. Optionally, the user is only charged for leads that are called. Optionally, the user is only charged for leads that are called and that have a certain result status (e.g., connected, message left, etc.) and is not charged for uncalled leads or for called leads that had an unsatisfactory result (e.g., disconnected, wrong number, deceased). Optionally, the user can pay a flat fee to utilize a set of database leads, whether or not they are called.

Optionally, payment received for leads can be divided among two or more entities. For example, the lead provider, the dialer provider, and a third party provider that hosts or provides the user interfaces described above, can each receive a portion (e.g., a dollar value or percentage) of payment for a lead (e.g., a called lead that has a specified status). In certain embodiments, the lead provider, the dialer provider, and the provider that hosts the user interfaces, can be the same entity. The system optionally provides a user interface accessible to one or more providers displaying/reporting their percentage and money earned on leads (e.g., on leads that incurred a charge to the user). The report optionally includes information on the amount of time a user (e.g., an agent) spent on the phone with a given lead, as will as the lead status reported by the user.

Optionally, as leads from a list are being called, usage and phone times measurements with respect to the interaction between a lead prospect and a broker is recorded for further use. An algorithm based on phone times and interactions (e.g., as evidenced by the user status reports) segments the list into what would be considered a hot list category and a cold list or no activity category. For example, the segmentation process can assign a relative value to a prospect based in whole or in part on the length of phone conversations with the prospect and/or based on the status assigned to a prospect by a broker that has called or spoken to the prospect. A higher value can be assigned to those prospects with whom a broker has had a relatively longer conversation and/or whom have received a “good” status. The leads identified as hot or more desirable can be associated with a higher cost for future users than those leads having little or no satisfactory activity counterparts. Optionally, those leads that are less desirable can be removed from a leads database. Optionally, the valuation process of leads can be performed by the leads provider based on feedback from agents/customers of the leads provider.

Certain processes and interfaces described above will now be described with respect to the figures.

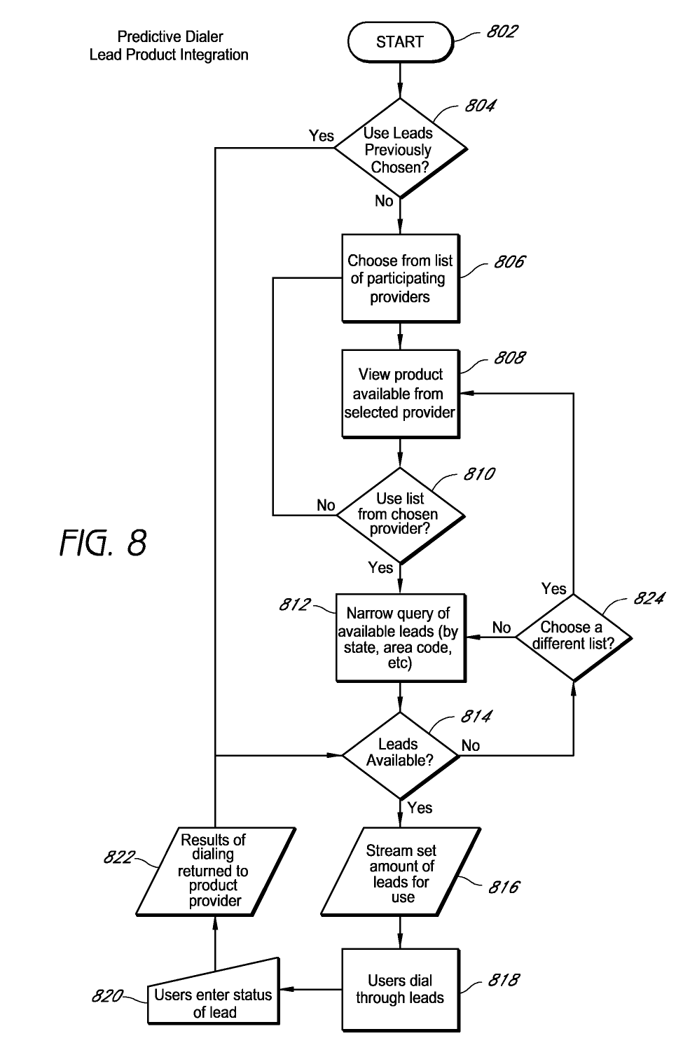

FIG. 8 illustrates an example process utilizing leads. The process begins at state 802. At state 804, a determination is made as to whether a user wants to use leads previously chosen by the user (e.g., an agent/supervisor). If the user chooses to use a new set of leads (e.g., via a menu selection), the process proceeds to state 806, and the user selects one or more lead lists from one or more providers (e.g., via a menu and/or by performing a search). At state 808 the user views one or more lists from one or more providers, identified at state 806. At state 810, a determination is made as to whether the user selected a list from a provider. If the user did not select a provider (e.g., the user activates a “Locate additional providers/lists control”, indicting that the user does not want to use/license the providers or leads databases identified at state 806), the process proceeds back to state 806, and the user can again attempt to locate a suitable provider or list.

If the user did select one or more lists from one or more providers, the process proceeds to state 812, and a user interface is presented via which the user can further narrow the leads to be used from the select list(s). For example, a form is optionally transmitted from the leads system to the user terminal via which the user can specify criteria that leads are to satisfy, such as a city, state, zip code, area code, time zone, in which the leads are to be located, an income level, an age, a gender, homeowner status, occupation, marital status, household size, number of children, age of children, and/or education level of the desired leads. At state 814, a determination is made as to whether any leads from the selected list(s) match the user's criteria. If there are leads that meet the criteria, the process proceeds to state 816, and the matching leads (e.g., a set amount of leads) are streamed to a dialer (e.g., a predictive or auto-dialer) for use.

At state 818, one or more users (e.g., agents/brokers) are connected to the leads. For example, if a predicative dialer is used, the predictive dialer optionally uses one or more algorithms to predict the availability of users (e.g., agents/brokers) and optionally to predict the number and/or timing of called lead answers. The dialer can adjust the calling of leads to attempt to match to the number of agents it predicts will be available when the calls placed, to number of leads that are expected to answer the lead calls. At state 820, users provide (e.g., via an electronic form) the status of leads they are connected to, and the status is stored in non-volatile memory and the status is optionally provided to the lead provider or other entity at state 822.

If, at state 804, the user elects to use previously chosen leads, that process proceeds to state 814, and a determination is made as to whether there are previously selected leads. The process then proceeds as similarly discussed above.

Several additional example user interfaces will now be described with respect to the figures. The user interfaces can optionally be in the form of Web pages presented via a browser, wherein the Web pages are served by a server associated with the employer of the intended users (e.g., agents/brokers), or by a third party server (e.g., an application service provider). The user interfaces can optionally be stored on, and accessed from a user terminal.

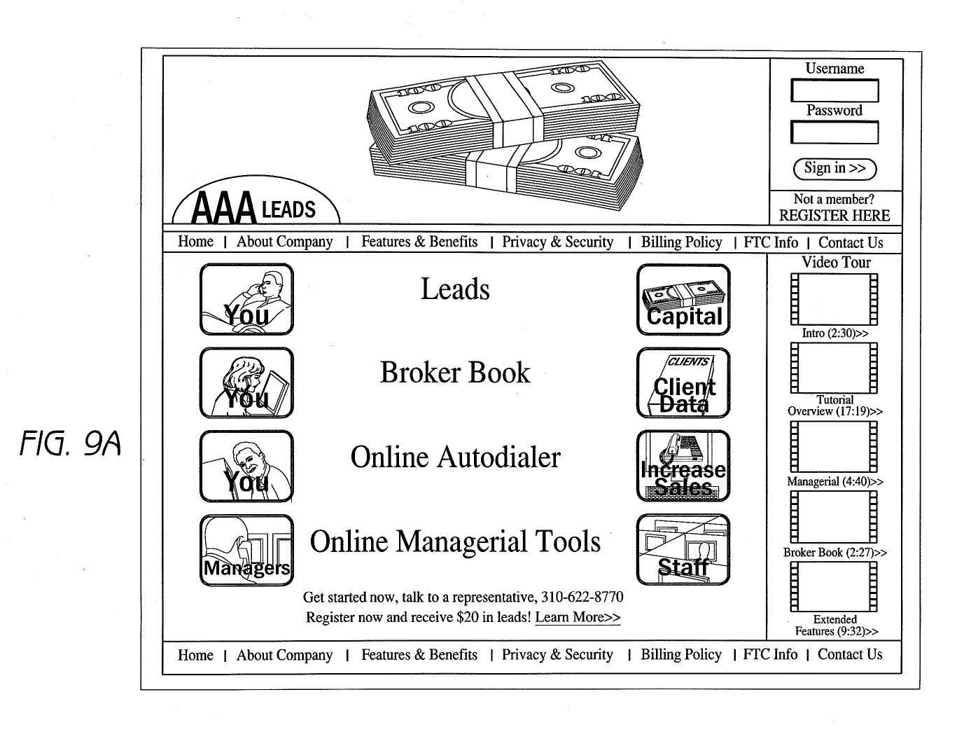

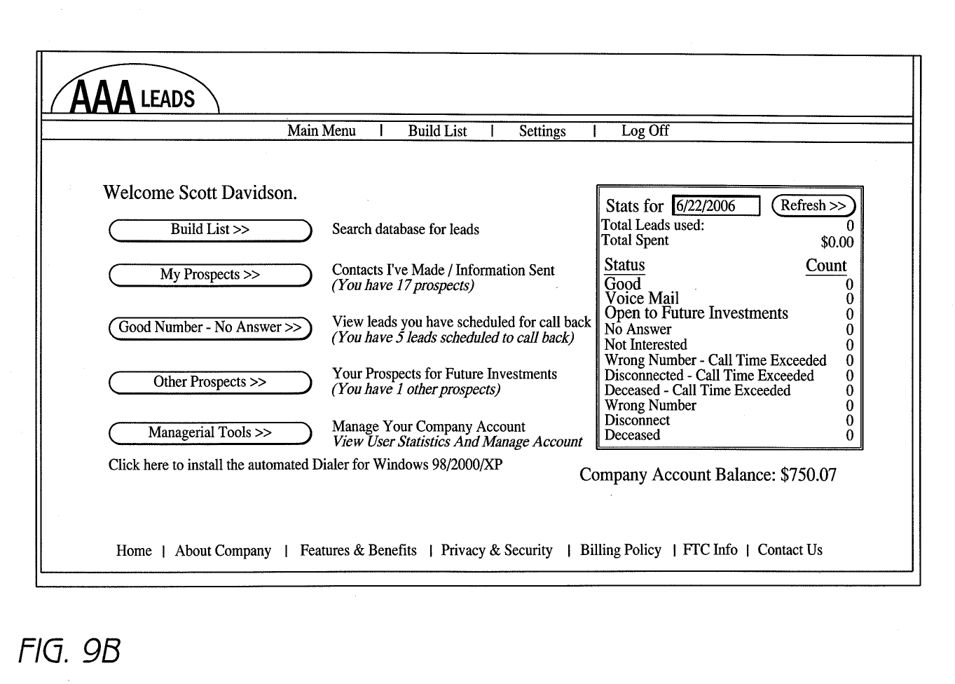

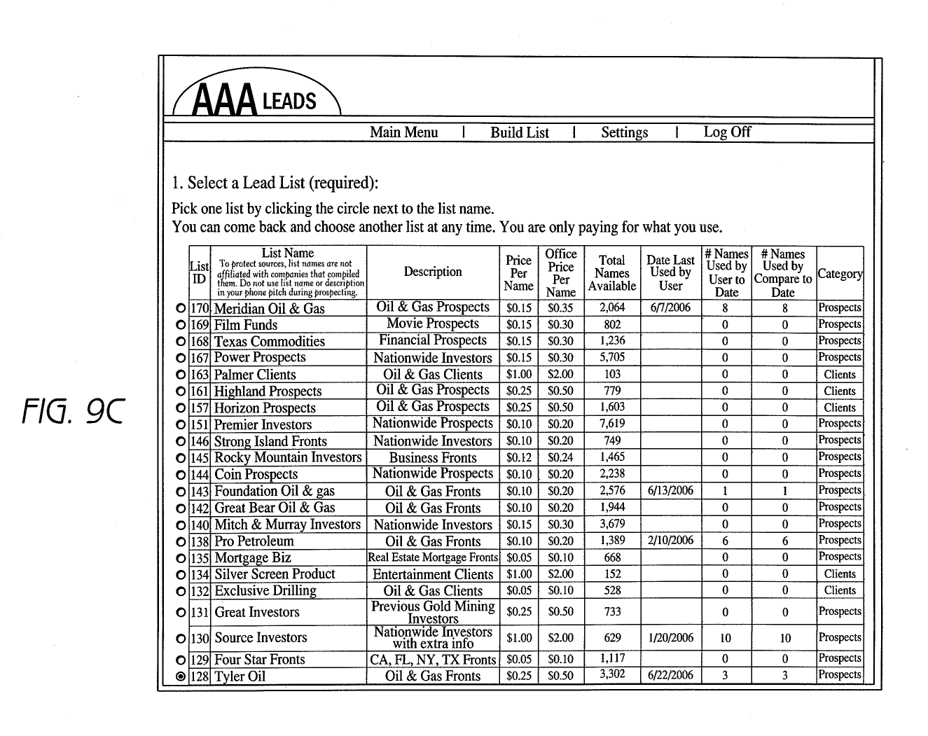

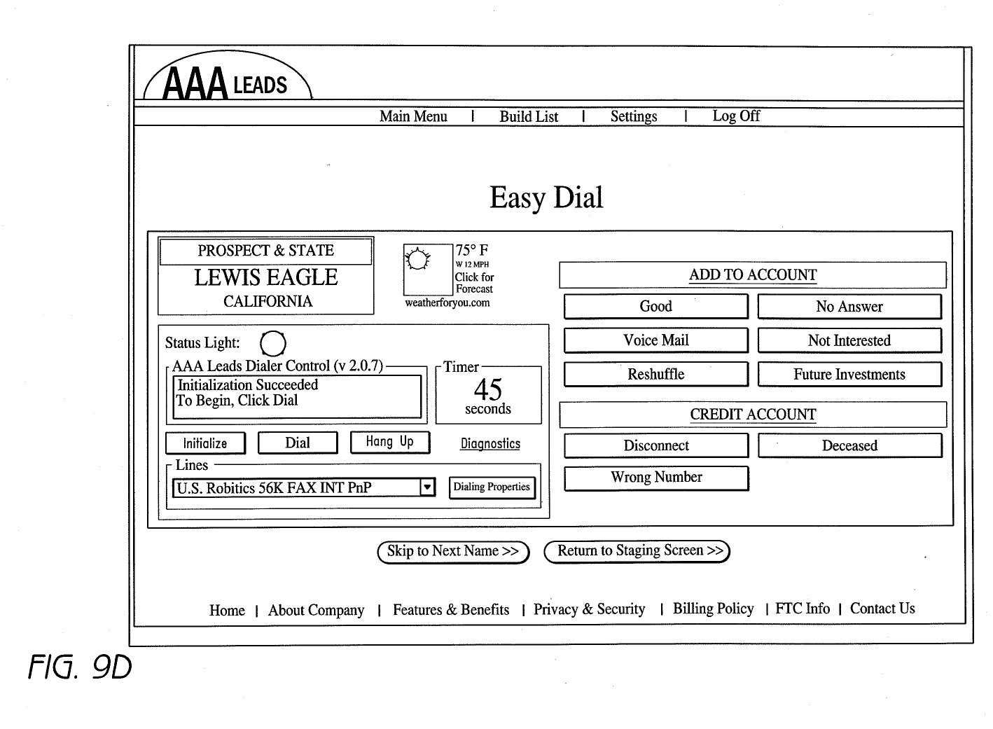

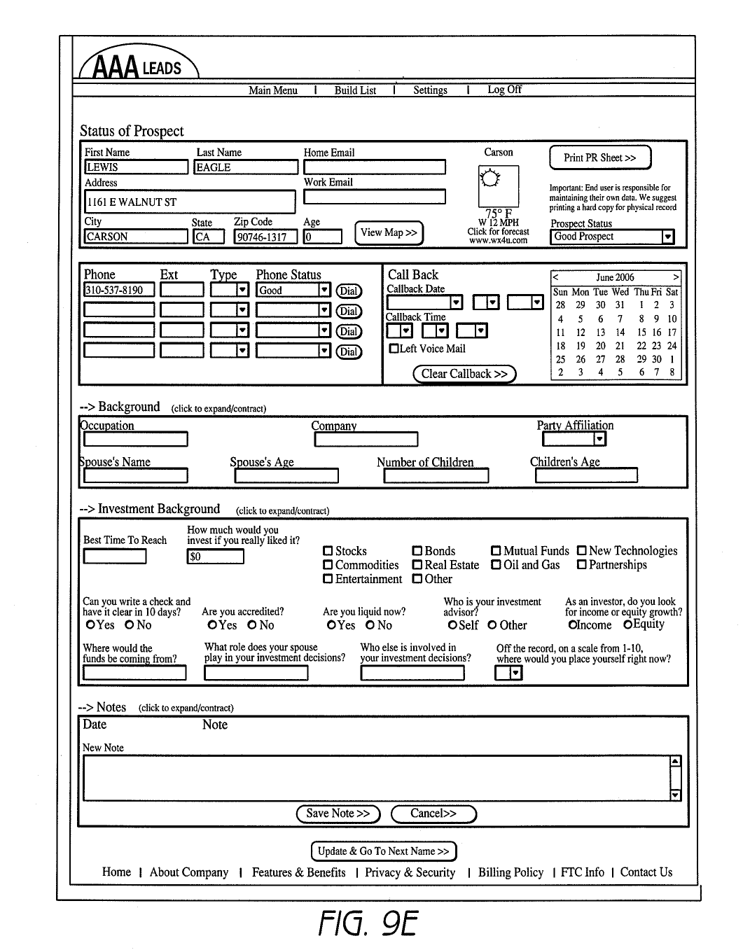

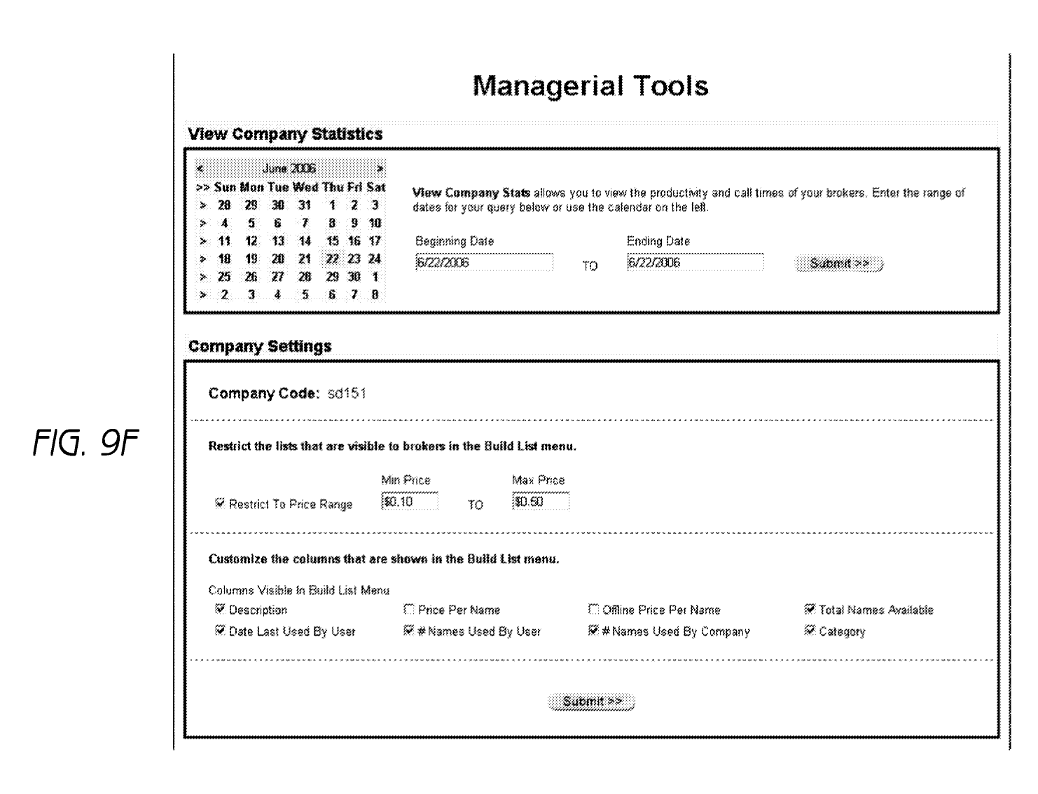

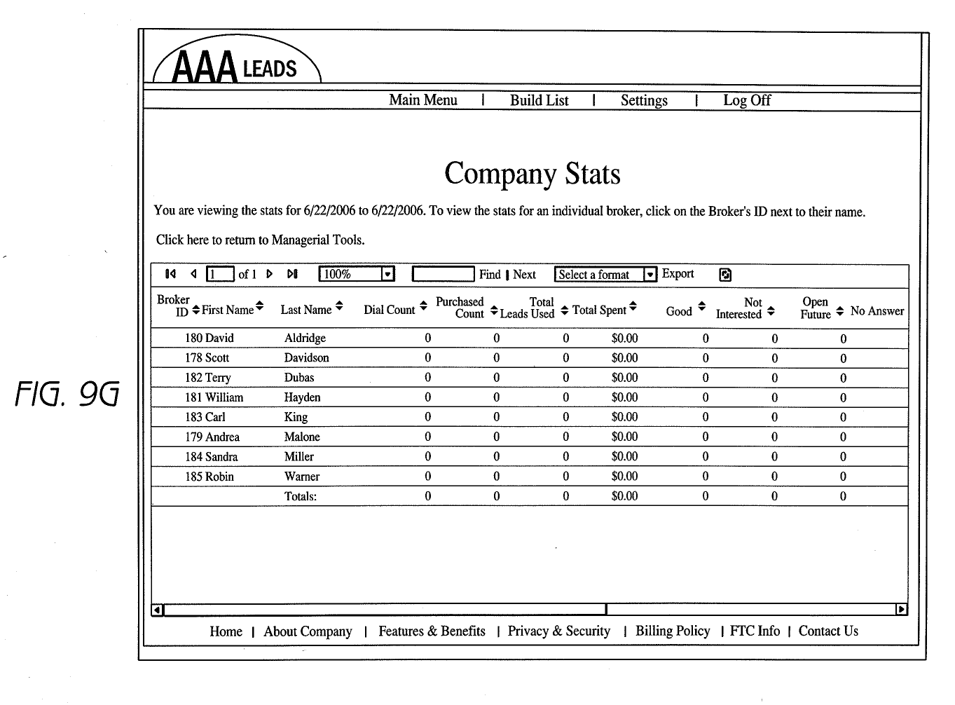

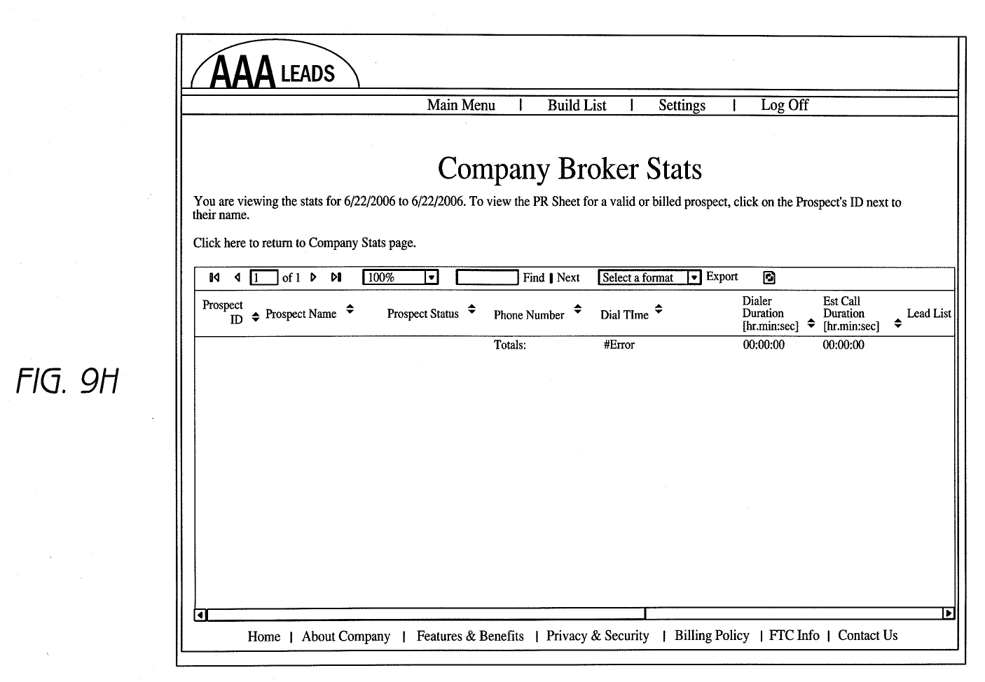

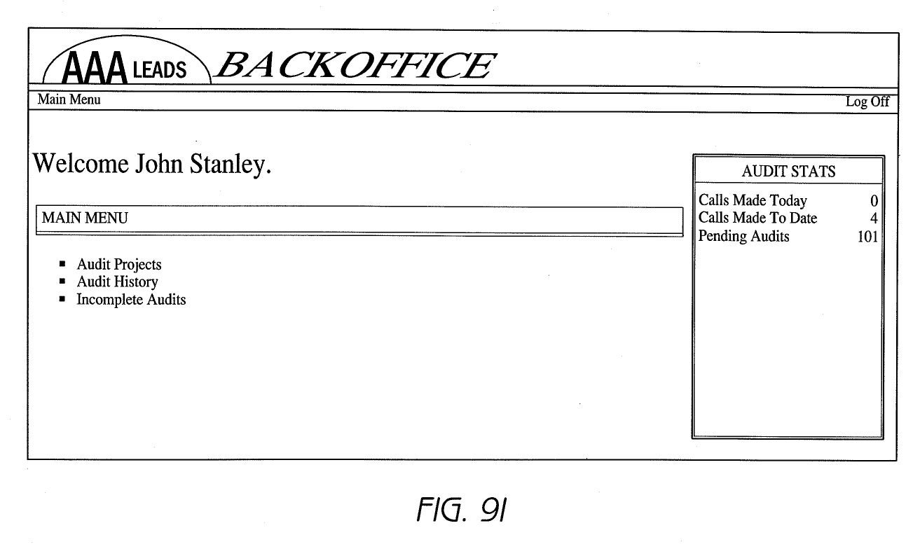

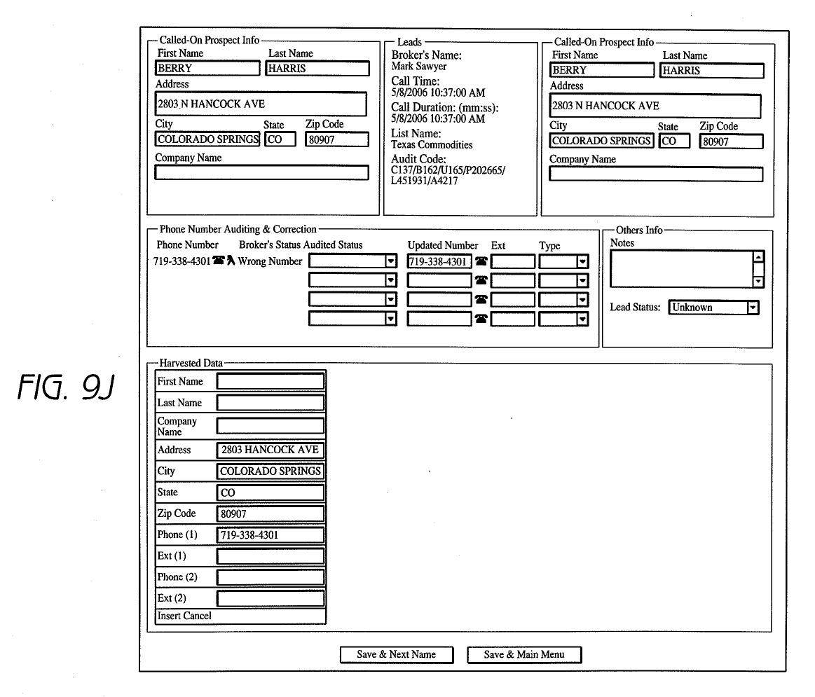

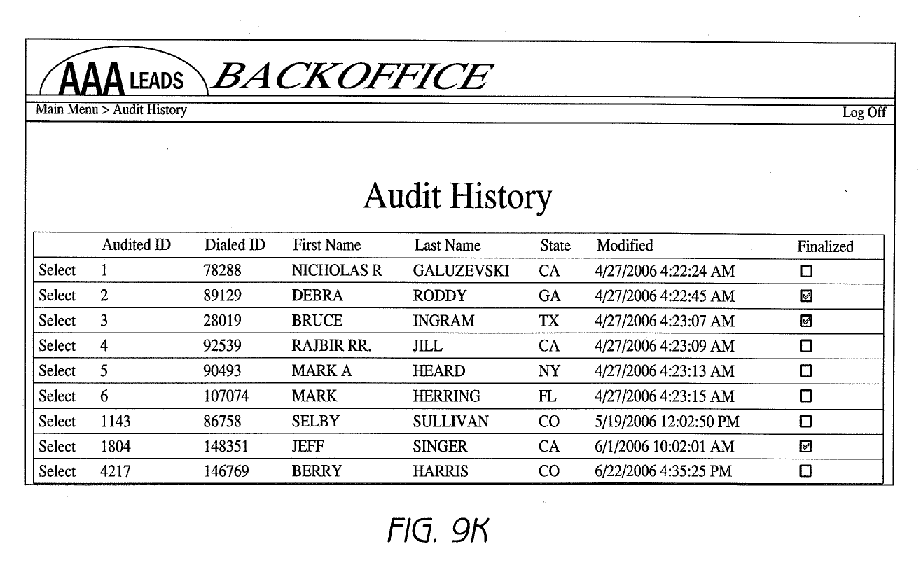

FIG. 9A illustrates an example “home page” or initial user interface. In this example, several links are provided, which when activated by a user, cause corresponding descriptions to be provided. In this example, links are provided to information on leads, a broker book, a dialer, and managerial tools.

Optionally in another embodiment, activation of the links/controls cause corresponding user interfaces to be presented to the user. For example, via corresponding controls (a leads control, a broker book control, a dialer control, a managerial tools control), the user can select to proceed to a “leads” user interface, via which a user can select and access leads, a broker book user interface, via which a user can view the lead call statistics for a given broker or other agent, a dialer user interface, via which a user can initiate calls to leads, and a managerial tools user interface, via which a manager can view broker statistics, identify which brokers are authorized to use which leads. For example, user interfaces are optionally provided via which a manager can identify which leads database a specified broker or group of brokers can utilize, the maximum and/or minimum priced leads a specified broker or group of brokers can utilize, the city, zip code, time zone, gender, and/or income of the leads a specified broker or group of brokers can utilize, etc.

For example, a manager can specify via a user interface that a broker can order leads from a specified set of providers, or can restrict the ordering of leads by a broker or other user to a subset of leads of available leads (e.g., by specifying call/no call states, area codes, etc.). By way of further example, a user interface is optionally provided via which an authorized manager can place spending limits on leads ordered by a given broker or group of brokers (e.g., a daily limit, a weekly limit, a monthly limit, and/or a total spending limit). Optionally to access and/or use some or all of the manager/audit tools, a user may be asked to provide identification/authentication information, such as a password or biometric information.

FIG. 9B illustrates an example leads user interface that include “build list”, “my prospects”, “good number—no answer”, “other prospects”, and “managerial tools” controls. Activation of the “build list” control causes a user interface to be presented via which a user can select or search for leads. Activation of the “my prospects” control causes a list of leads contacted by the user to be presented (e.g., those leads that indicated interest in a good or service, such as an investment, being offered or promoted by the user/broker). Optionally, the example leads user interface displays the number of user prospects, which is optionally limited to a specific time period (e.g., today, this week, this month, this year, etc.). Activation of the “good number—no answer” control causes a list of leads scheduled for a callback by the user to be presented. Optionally, the example leads user interface displays the number of scheduled callbacks. Activation of the “other prospects” control causes a list of leads for future investments to be presented, wherein the prospects had previously been contacted by the user and while the prospects were not interested in the particular good or service (e.g., investment) that was offered or promoted by the user, the prospects indicated an interest in hearing future offers of other goods or services. Optionally, the example leads user interface displays the number of other prospects. Activation of the “managerial tools” control causes a user interface to be presented via which an authorized manager or other authorized user can manage a leads account and can view user statistics (e.g., the number of leads called, the number of status reports filled out by a broker, the breakdown of the status reports, the average time spent talking with a lead, etc.).

The example user interface provides statistics for a specified day or period (e.g., provided in a date field, or start date/end date fields). For example, using information retrieved from a database, for the specified date/period the user interface can report on total number of leads used, the total amount spent on leads, the total number of leads the received a status of “good”, “voice mail”, “no answer”, “not interested”, “wrong number—call time exceeded”, “disconnect—call time exceeded”, “deceased—call time exceeded”, “wrong number”, “disconnect”, “deceased.” Optionally, an account balance for the user's account and/or employer's account is reported.

FIG. 9C illustrates an example user interface via which a user can select a lead list. Some or all of the following information is provided for a given lead: a list identifier number, a descriptive name/identifier (optionally with or without providing the list source name), a description, a price per lead/name (e.g., for when a charge is made for the lead after the lead has been used and/or when the lead has a certain status reported by the user, wherein the lead phone number is not displayed to the user prior to the user being charged for the lead), an offline price per lead/name (e.g., where a charge is made for the lead if the lead is provided (e.g., downloaded or provided via hardcopy), whether or not the lead is called, wherein the lead phone number is provided for display to the user), a total number of lead names available in the list, a date when the lead list was last used by the user, and number of leads used by the user's company to date (or within a specified time period), and a category (e.g., prospective clients, existing clients, etc.).

FIG. 9D illustrates an example user interface which enables a user to initiate the dialing of a lead without revealing the lead phone number. The example user interface displays the prospects name, state (and optionally city, zip code, area code, and/or other location related information). The weather in the prospect's area is optionally displayed (e.g., temperature, wind information, rain, sun, cloud information, forecast information, a link to addition weather information, etc.).

Optionally, other or different localized content can be displayed as well for the prospect (e.g., selected based on the prospect's city, state, zip code, and/or area code). For example, information (e.g., scores, game descriptions, standings, trades, other sports news) regarding a local sports team can be presented. Other local news can also be presented (e.g., related to crime, politics, local events, etc.). The localized content can optionally be presented in Web page form, as an electronic ticket tape, via RSS (Real Simple Syndication) feeds, or otherwise. A broker or other agent can use such localized content to initiate or engage in conversation with a prospect to make the prospect feel more comfortable and at ease. The localized content can be pulled (e.g., via a client application resident on the user's terminal) or pushed from a remote computer server (e.g., from the dialer or other computer system). Optionally, the user or a supervisor can specify what types of localized content are to be displayed, as well as which personal data regarding the prospect is to be displayed.

As similarly discussed above, optionally, the system can automatically (or in response to a user request) perform or initiate a search regarding the lead. For example the system can submit a search query to a local and/or Web-based search engine (e.g., Google, Yahoo, MSN, etc.) that have access to one or more databases (e.g., an index/data store of Web pages and/or of private credit databases, or other databases) using certain information related to the lead as search terms (e.g., the lead's name, city, state, address, zip code, phone number, age, occupation, marital status, and/or educational institutions attended by lead, etc.), wherein some or all of the lead information used as search terms is provided by the leads provider.

Optionally, the user and/or a supervisor can specify what types of search terms are to be used via a selection form user interface. All or certain higher ranked search results (e.g., the top three results) are then transmitted to the user's computer terminal for display to the user. Optionally, the user and/or a supervisor can specify how many results are to be returned and/or displayed to the user.

The search results can provide the user with additional information and news about the lead, which can help the user better project or infer what the lead's needs or interests might be and can help establish a better rapport with the lead.

The user interface optionally displays the call dialing/connection status (e.g., initializing, initialization completed, dialing, ringing, connected, etc.) and instructions (e.g., “to begin, click dial”). A dial control is provided, which, if activated causes the prospect phone number to be dialed. A “lines” field displays information on the line and/or interface used to connect to the lead (e.g., a modem name, a modem type, etc/).

Prospect status input controls are provided via which the user can report the results of the call to the prospect. Optionally, the input controls are arranged according to whether the call to the lead will incur a charge or not. In this example, “status”, “voice mail”, “reshuffle”, “no answer”, “not interested”, “future investments” controls are grouped as an “add to account” group (billable), and “disconnect”, “wrong number”, and “deceased” are grouped as a “credit account” group (not billable). A “skip to next name” control is provided, which, if activated, causes the next lead to be presented to the user.

Optionally, if a predictive dialer is used, the dialer automatically dials the lead number, and if the dialer determines that the call is answered by a person, the dialer connects an agent to the lead and presents similar information as that illustrated in FIG. 9D. Optionally, in such as environment, the dial control and lines filed are not presented to the user.

FIG. 9E illustrates an example prospect report form. This example is oriented for investment prospects, other fields can be used for other types of prospects. Some or all of the fields may be pre-populated using information from the corresponding database lead record, and optionally a user (e.g., a broker) can correct or enter form data using information obtained from the prospect, and then save and store the information and corrections.

The example form includes name fields (e.g., first name, last name), address fields (e.g., address, city, state, zip code, apartment number), home email field, work email field, a link to a map of the lead's location and surrounding area, weather information for the lead's area, and a prospect status field. Optionally, one or more phone fields, one or more corresponding phone status fields, and corresponding dial controls are provided. A call back area includes call back date fields, call back time fields, a left voice mail indicator field, a month calendar, and a clear callback control.

A background area includes fields for occupation, company name, political party affiliation, a spouse name, a spouse age, number of children, and children's ages. An investment background area includes fields for best time to reach the prospect, how much the prospect would be willing to invest, and the prospects investment product history (e.g., stocks, commodities, entertainment, bonds, real estate, mutual funds, oil and gas, new technologies, partnerships, other investments). Fields are also optionally provided via which the user can indicate when the prospect would be able to pay for an investment, whether the prospect is accredited, whether the prospect is currently liquid, who is the prospect's investment advisor, whether the prospect is interested in income or equity. Fields are optionally provided via which the user can indicate from where the prospect's investment funds will be obtained, what role the prospect's spouse plays in making investment decisions, who else is involved in making the prospect's investment decisions, and how the prospect rates the prospect's current investments. In addition, a notes area is provided via which the user can enter free form notes.

FIG. 9F illustrates an example manager user interface via which an authorized user (e.g., a manager) can view company statistics related to leads for a specified period (e.g., a selected month or a period defined by a start date and an end date).

A company settings area includes a company identifier (e.g., a code that corresponds to the company whose account settings are being specified). A field (e.g., a check box or control) is provided via which the user can indication that a specified price range is to be used for leads lists that can be accessed and/or displayed to brokers associated with the company. In this example, a minimum price per lead field and a maximum price per lead field are provided via which the user can specify minimum and maximum lead prices. Optionally, if the user does not enter a minimum price, the system will assume that there is no minimum price. Optionally, if the user does not enter a maximum price, the system will assume that there is no maximum price.

The user can further specify the list data that is to be displayed to brokers and/or the user (e.g., in table format, such as that illustrated in FIG. 9C). For example, the user can specify that some or all of the following lead list data is to be transmitted to, and displayed on a broker or other user terminal: lead list description, price per name (lead), offline price per name (lead), total number of names (leads) available, date lead list was last used by the broker (or other user), the number of lead list names (leads) used by the broker (or other user), the number of names (leads) used by the company, and/or the lead list category.

FIG. 9G illustrates an example company statistic report which is optionally accessible only to authorized users (e.g., a manager). The report provides, in table format, some or all of the following: a broker identifier, a first name, a last name, a dial count (e.g., number of calls to leads where the broker was connected to a called lead), a purchased count (the number of leads associated with the broker for which there was a charge), a total leads used (e.g., the number of leads that were called), a total spent (e.g., the charge incurred for the broker's lead usage), the number of good leads (e.g., based at least in part on a designation provided by the broker), the number of leads that were not interested in the investment being offered by the broker, the number of leads that indicated they may be interested in a future investment offering, and the number of lead calls that were not answered. Optionally, clicking on an entry associated with a broker (e.g., a broker ID or name entry/link) causes additional information regarding the selected broker to be presented, such as illustrated in the example presented in FIG. 9H.

Referring back to FIG. 9G, a percent field is provided via which the user can specify the percent of brokers for whom the information is to be provided. Optionally, a field can be provided via which a user can specify that a report is to be generated for a specified department or other grouping or subset of brokers. One or more fields are optionally provided via which the user can specify the report time frame. The report can optionally be updated in substantially real time and can be transmitted over a network to a remote user terminal for display via a browser of other interface. The user can instruct the system to export the data into a specified format (e.g., an Excel spreadsheet format, a text file format, etc.).

Referring to FIG. 9H, an example user interface is illustrated that provides a report for a user selected broker for a user selected period of time. For the leads called by or on behalf of the caller, the report lists some or all of the following: a prospect/lead identifier, a prospect name, a prospect status, a prospect phone number, a dial time (the time the call to the prospect was placed), a dialer duration (e.g., the time between initiating a call or being connected to a lead and the broker providing status, such as by clicking on a status selection), an estimated call duration (e.g., the actual length of the call to the lead), a lead list identifier, a lead list name (not shown), a lead list source (not shown), and a lead charge (not shown). The report can optionally be updated in substantially real time and can be transmitted over a network to a remote user terminal for display via a browser of other interface.

FIG. 9I illustrates an example audit main menu which can be used to verify the lead status provided by a user, such as a broker, and to update lead information (e.g., phone number and status information). In this example, menu entries are provided for auditing prospects, auditing history, and incomplete audits.

FIG. 9J illustrates an example audit form, including a prospects info area (e.g., including fields for the prospects name, address, and company name), and a lead statistics area (e.g., including fields for the broker's name, the time when the call to the lead was placed, the call duration, the lead list name from which the prospect was obtained, and/or an audit code). A phone number auditing and correction area includes fields for displaying the status provided by the broker (e.g., wrong number, deceased, disconnected) for a given lead phone number, and a field (optionally in the form of a drop menu having selectable choices) for receiving an audited status provided by an auditor for a given lead phone number, and fields for receiving updated phone number, extensions, and phone types (e.g., work, home, mobile). A notes field is provided via which an auditor can enter free form notes. A lead status field is provided via which the auditor can provide an overall lead status (e.g., deceased) rather than or in addition to a lead phone number status. A harvested data area includes fields displaying lead information obtained by the broker and/or for receiving information from the auditor (e.g., name, company name, address, and phone number information). A save control is provided for saving information entered into the form into memory.

FIG. 9K illustrates an example audit history report, including an audit identifier, a dialed identifier (corresponding to the lead and/or lead phone number audited), a lead first name and a lead last name, the lead state, the date/time the audit was performed and/or the auditor modified lead data, and a finalized field indicating whether the audit is complete.

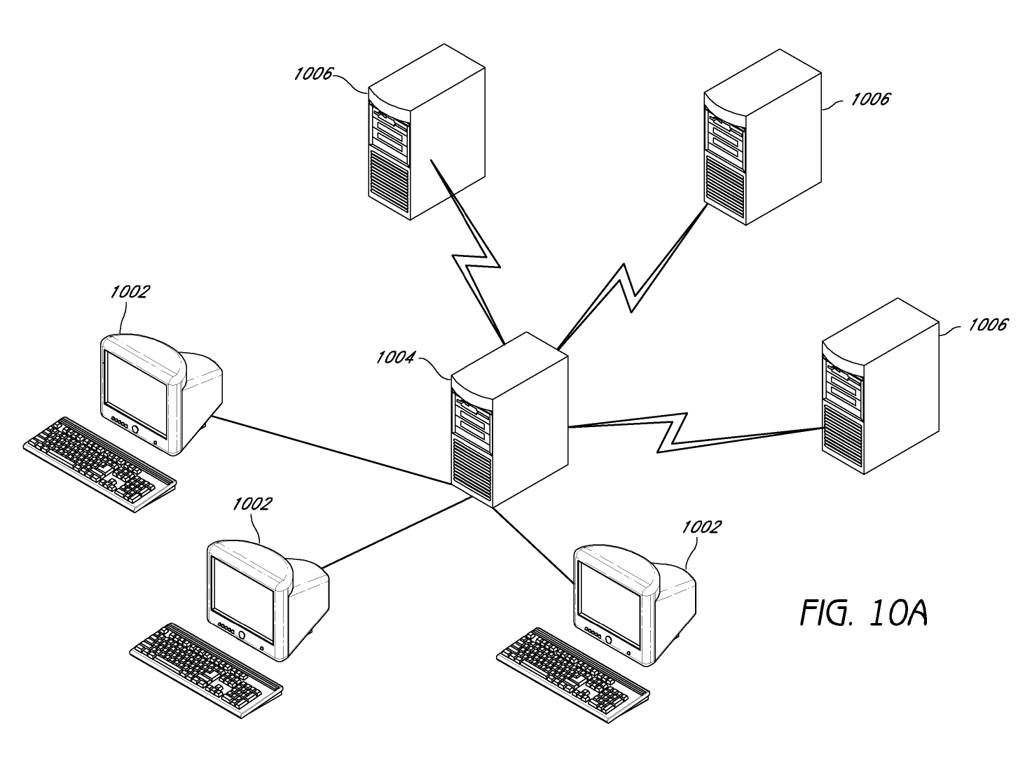

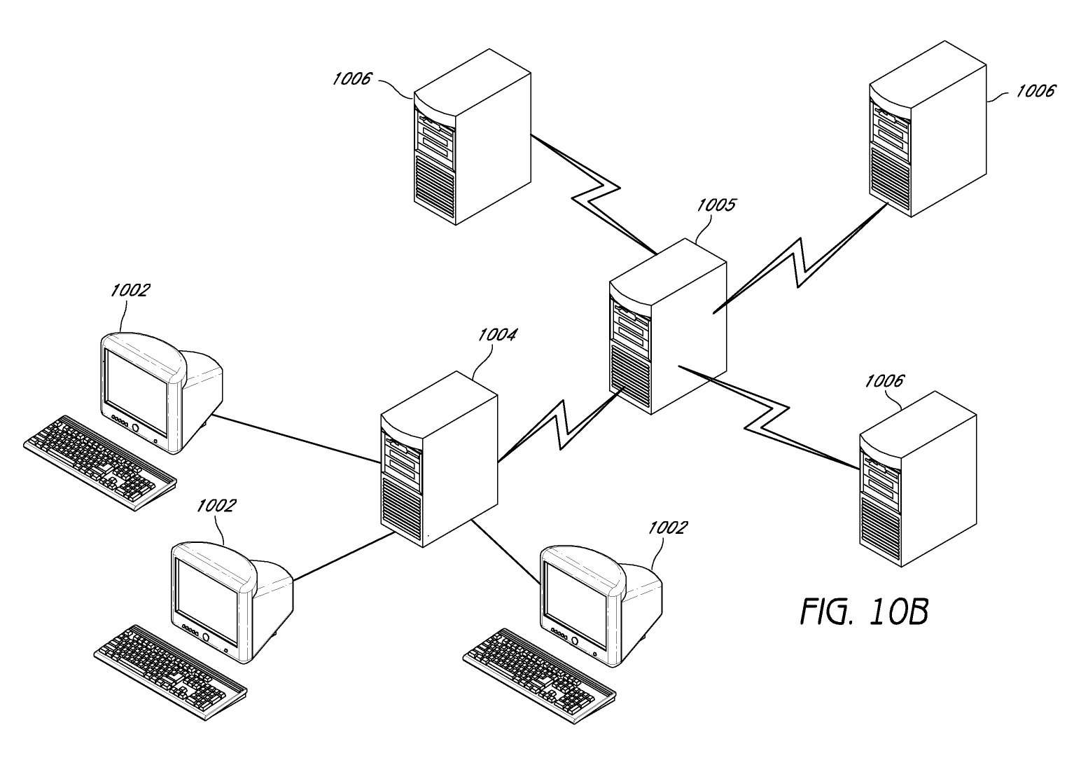

FIGS. 10A-B illustrate example networked system configurations. Referring to FIG. 10A, user terminals 1002 are coupled to a dialer server 1004 (e.g., a predictive dialer) over a local network or a wide area network. Thus, the dialer server 1004 can optionally be located on site with the terminals 1002 or offsite. The user terminals 1002 optionally include VoIP phones. Optionally, a POTs phone is provided in addition or instead. The dialer 1004 is connected over a wide area network (e.g., the Internet) to one or more product servers 1006, optionally associated with different lead list providers. The product servers 1006 store or provide access to leads databases. In an example embodiment, once leads are selected by or for the users associated with the terminals 1002, the data (e.g., phone number and other lead information, such as that discussed above) corresponding to the leads is downloaded or streamed to the predictive dialer (optionally on an as-needed basis).

The dialer server 1004 automatically dials the leads, and when a call is answered by a human, the dialer connects the call to an available user (e.g., via the user's terminal 1002 or other phone), and transmits lead information (e.g., name, weather, location, etc., as similarly discussed above) for display on the user terminal (e.g., in the form of a Web page). The dialer server 1004 optionally receives and stores lead status information provided by users and optionally transmits the status information to the provider associated with the product server from which the lead originated.

FIG. 10B illustrates another example networked system. However, in this example, an intermediary product server 1005 is provided that connects to the products servers 1006 over a wide area network, the predictive dialer server 1004 over a local or wide area network, and optionally to the user terminals 1002 over a wide area or other network. The intermediary product server 1005 is optionally operated by a third party, such as an entity that aggregates information about lead lists (e.g., name, size, cost per lead, etc.) from the providers associated with the servers 1006, and transmits some or all of the aggregated information to the terminal 1002 (e.g., in response to a user request as similarly discussed above).

The intermediary product server 1005 can accept orders from users provided via the user terminals 1002, transmit corresponding requests for leads to the appropriate product servers 1006, receive the lead information from the servers 1006, and download or stream lead information (e.g., phone numbers and other information) to the dialer 1004, which can then place calls and connect calls to users as similarly described above. The server 1005 can also receives and store lead status information provided by users and optionally transmits the status information to the provider associated with the product server from which the lead originated. The server can store call information, charge information, and other information described herein relating to calls placed to leads, and can optionally generate one or more of the reports described herein, and provide the reports to appropriate users.

Thus, certain of the example processes described above enable a user to use a user interface to view and select lead lists from a plurality of providers. Further, certain of the example processes described above enable leads to be retrieved from a third party on an as-needed basis, without having to purchase a predetermined amount of leads in advance. This enables end-users/managers to control spending on a case-by-case basis. Additionally, where leads are paid for on an as-used basis, if a particular source or list of leads is unsatisfactory (e.g., not performing as desired or is now deemed too expensive), the end-user/manager can choose, on the fly, a different list or source of leads to call, without having to pay for unused leads from the unsatisfactory source of leads.

The leads database product provider optionally also benefits from certain of the processes described herein. For example, using the call status reports provided by end-users, a leads database provider can “clean” or improve their databases by removing bad leads and phone numbers (e.g., wherein a call to a listed lead's phone number result in a disconnect or a wrong number), or by flagging which leads needs to be corrected for future use. This enables providers to sell more accurate product with inaccurate information removed. Because these providers' leads databases are likely to be more accurate, the databases may be more attractive to users, and hence, licensed more by users. In addition, providers may be able to charge more for use of their leads databases.

Further, certain processes (e.g., those relating to streaming the lead list product to automated dialers) may result in a more rapid rate of calls to leads, which will, in certain circumstances, result in a higher income from the leads database.

It should be understood that certain variations and modifications of this invention would suggest themselves to one of ordinary skill in the art. The scope of the present invention is not to be limited by the illustrations or the foregoing description thereof.

What is claimed is:

1. A calling system, comprising:
a user interface configured display prospect database identifiers associated with a plurality of database associated with a plurality of database providers;
a user interface configured to receive a prospect search query from a user;
a search engine configured to locate one or more sets of leads corresponding to the prospect search query;
a user interface configured to display identifiers corresponding to one or more of the located sets of leads and to receive a user selection;
programmatic code stored in computer readable memory configured to cause, at least in part, lead phone numbers corresponding to the user selection to be provided to an autodialer associated with the user; and
a user interface configured to receive status indications from the user with respect to at least a portion of the streamed leads, wherein the status indicates corresponding call results.

2. The calling system as defined in claim 1, wherein the dialer is configured to couple communication devices associated with corresponding users to calls dialed by the dialer.

3. The calling system as defined in claim 1, further comprising the dialer.

4. The calling system as defined in claim 1, further comprising the dialer, wherein the dialer is a predictive dialer.

5. The calling system as defined in claim 1, wherein the lead phone numbers are streamed to the dialer.

6. The calling system as defined in claim 1, including programmatic code stored in computer readable memory configured to generate invoices based on the status indications.

7. The calling system as defined in claim 1, wherein the programmatic code is further configured to cause names of leads to be displayed in association with connected calls to the leads without enabling the user to view the called lead phone numbers.

8. The calling system as defined in claim 9, further comprising a data store that maintains a record of prospect phone numbers successfully called, and the cost for utilizing a prospect phone number.

9. A calling system, comprising:
a dialer;
a user interface via which a user can select one or more sets of prospects from a plurality of sets of prospects from different providers; and
programmatic code stored in computer readable memory configured to cause at least in part phone numbers to be streamed from the one or more user selected sets of prospects to the dialer so that the dialer can dial the phone numbers.

10. The calling system as defined in claim 9, wherein the dialer is a predictive dialer.

11. The calling system as defined in claim 9, wherein the calling system does not enable the dialed phone numbers to be displayed to the user.

12. The calling system as defined in claim 9, wherein corresponding contact information for the plurality of sets of prospects is stored in multiple remote databases controlled by different providers.

13. The calling system as defined in claim 9, further comprising a network interface configured to be coupled to a plurality of remote prospect databases associated with the different providers.

14. The calling system as defined in claim 9, further comprising a network interface configured to access a plurality of terminal associated with a plurality of users.

15. The calling system as defined in claim 9, further comprising a data store that maintains a record of phone numbers called, and the cost for utilizing a prospect phone number.

16. A method of providing contact information, comprising:
causing at least in part identifiers for a plurality of databases storing contact information for leads from a plurality of providers to be displayed to a user via a user display;
receiving over a network a user selection of at least a portion of at least one of the databases;
at least partly causing phone numbers corresponding to the selected portion to be transmitted to a dialer;
receiving over the network user specified call status for calls completed via the dialer and connected to the user; and
storing the user specified call status in a data store.

17. The method as defined in claim 16, the method further comprising:
receiving a leads search query specified by the user; and
identifying at least a portion of the leads stored in the plurality of databases that match the leads search query.

18. The method as defined in claim 16, transmitting at least a portion of the user specified call status to at least one provider of the leads.

19. The method as defined in claim 16, wherein the identifiers are displayed in association with a cost per lead.

20. The method as defined in claim 16, the method further comprising transmitting to a user terminal an indication as to how many leads from a first set of leads has been called on behalf of the user.

21. The method as defined in claim 16, wherein the user is not charged for uncalled leads from the selected set of leads.

22. The method as defined in claim 16, the method further comprising further comprising a menu via which the user can select at least a first status indication including at least the following status-types: good, not interested; wrong number.

23. The method as defined in claim 16, the method further comprising further comprising providing a user interface via which the user can indicate if a lead database selected during a prior session is to be used.

24. The method as defined in claim 16, wherein the dialer is a predictive dialer.

25. The method as defined in claim 16, the method further comprising generating a report regarding lead usage including a descriptive identifier of at least a first lead database utilized by at least one user and a price per lead for the use of at least a portion of the leads in the first lead database.

26. A system for controlling calling, comprising:
a user interface including a field via which a first user can specify a maximum permissible cost for leads that can be used by a first set of users;
a data store configured to store the maximum permissible cost specified by the first user; and
a report generator configured to generate a report with respect to how many lead phone numbers were utilized by the first sets of users and the cost associated cost on a per lead basis.

27. The system as defined in claim 26, further comprising a user interface via which the first user can specify a city, zip code, time zone, gender, and/or income of the leads at least one user from the first set of users can utilize.

28. The system as defined in claim 26, further comprising a user interface including a field via which the first user can specify what and/or how lead data is to be presented to the first set of users.

29. The system as defined in claim 26, wherein the first user can specify that the first set of users is not to be provided with leads associated with one or more specified states.

30. The system as defined in claim 26, further comprising a user interface including a field via which the first user can specify a lead spending limit for at least one user from the first set users.

31. The system as defined in claim 26, further comprising a predictive dialer configured to receive streamed lead phone number.

32. The system as defined in claim 26, wherein the reporting system is configured to generate a report that includes the status of calls in which users from the first set of users engaged.

33. The system as defined in claim 26, wherein the reporting system is configured to generate a report that includes an identification of a provider of leads used by at least one user from the first set of users.

34. The system as defined in claim 26, wherein the reporting system is configured to generate a report that includes a cost per lead for leads utilized by at least one user.

35. The system as defined in claim 26, wherein the system is further configured to cause a billing event to occur for leads that are associated with a successful call status provided by at least one user.

36. A calling system, comprising:
a leads database server;
a dialer server;
a network interface configured to be coupled to a plurality of user terminals; and
programmatic code stored in computer readable memory, which when executed, is configured to receive a selection of a set of leads from a user and to stream lead phone numbers from the leads database server to the dialer server, and to receive indications from users as to which called leads resulted in a billable event.

37. The calling system as defined in claim 36, further comprising a user interface configured to be coupled to a plurality of remote leads databases associated with a corresponding plurality of providers.

38. The calling system as defined in claim 36, wherein the dialer server includes a predictive dialer.

39. The calling system as defined in claim 36, further comprising a report generator configured to generate a report regarding the user indications.
